(19) United States
(12) Patent Application Publication
(10) Pub. No.: US 2026/0227333 A1
(43) Pub. Date: Aug. 6, 2026

(54) IMAGE ACQUISITION METHOD, FLUORESCENCE MICROSCOPE, EXCITATION LIGHT IRRADIATION UNIT AND WAVEFORM CONTROL UNIT

(71) Applicant: HAMAMATSU PHOTONICS K.K., Hamamatsu-shi, Shizuoka (JP)

(72) Inventors: Kyohei SHIGEMATSU, Hamamatsu-shi, Shizuoka (JP); Shigetoshi OKAZAKI, Hamamatsu-shi, Shizuoka (JP); Naoya MATSUMOTO, Hamamatsu-shi, Shizuoka (JP); Koyo WATANABE, Hamamatsu-shi, Shizuoka (JP); Takashi INOUE, Hamamatsu-shi, Shizuoka (JP)

(73) Assignee: HAMAMATSU PHOTONICS K.K., Hamamatsu-shi, Shizuoka (JP)

(21) Appl. No.: 19/119,176

(22) PCT Filed: Aug. 25, 2023
(86) PCT No.: PCT/JP2023/030757

§ 371 Date: Apr. 8, 2025

(30) Foreign Application Priority Data
Oct. 13, 2022 (JP) 2022-164516

(51) Int. Cl. G01N 21/64

(52) U.S. Cl. CPC G01N 21/6458; G01N 21/6408

(57) ABSTRACT

An image acquisition method includes: a step of generating an excitation optical pulse group including a plurality of excitation optical pulses repeatedly; a step of emitting the excitation optical pulse group to an object containing a fluorescent dye; a step of detecting intensities of fluorescence generated at a plurality of locations of the object due to emission of the excitation optical pulse group; and a step of generating a fluorescent image based on the intensities of the fluorescence at the plurality of locations of the object. In the step of generating the excitation optical pulse group, a time interval between the plurality of excitation optical pulses is set to be equal to or shorter than a relaxation time between excited triplet states of the fluorescent dye or to be shorter than 10 picoseconds.

### TECHNICAL FIELD

The present disclosure relates to an image acquisition method, a fluorescence microscope, an excitation beam irradiation unit, and a waveform control unit.

### BACKGROUND ART

Patent Literature 1 and Non Patent Literature 1 disclose that the pulse interval of the excitation optical pulse is set to 10 picoseconds to 50 picoseconds or more in order to reduce bleaching of fluorescence when a fluorescent dye is excited. Non Patent Literature 2 discloses that the pulse interval of the excitation optical pulse is made longer than 1 microsecond in order to reduce bleaching of fluorescence when a fluorescent dye is excited. Patent Literature 2 discloses a fluorescence microscope in which the number of pulses and the pulse interval of excitation beam are controlled.

### CITATION LIST

### Patent Literature

Patent Literature 1: WO2009/035768
Patent Literature 2: U.S. Patent Application Publication No. 2010/0187208

### Non Patent Literature

Non Patent Literature 1: Na Ji et al., “High-speed, low-photodamage nonlinear imaging using passive pulse splitters,” Nature Methods, Volume 5, No. 2, pp. 197-202 (2008)
Non Patent Literature 2: Gerald Donnert et al., “Major signal increase in fluorescence microscopy through dark-state relaxation,” Nature Methods, Volume 4, No. 1, pp. 81-86 (2007)

### SUMMARY OF INVENTION

### Technical Problem

A fluorescence microscope irradiates a plurality of locations of an object containing a fluorescent dye with excitation beam, detects fluorescence emitted from the fluorescent dye, and outputs a fluorescent image. In such a fluorescence microscope, the object may be irradiated with pulsed excitation beam. For example, in a multiphoton excitation fluorescence microscope, an object is irradiated with an excitation optical pulse having an extremely short pulse width, for example, on the order of picoseconds or femtoseconds, in order to cause multiphoton absorption by increasing the photon density of the excitation beam. However, if the fluorescence is continuously detected while emitting the excitation optical pulse, the fluorescence intensity gradually decreases. This phenomenon is called photobleaching. Since photobleaching limits the object observation time, it is desirable to reduce the photobleaching in the fluorescence microscope.

It is an object of the present disclosure to provide an image acquisition method, a fluorescence microscope, an excitation beam irradiation unit, and a waveform control unit that can reduce photobleaching.

### Solution to Problem

[1] An image acquisition method according to one embodiment includes: a step of generating an excitation optical pulse group including a plurality of excitation optical pulses repeatedly; a step of emitting the excitation optical pulse group to an object containing a fluorescent dye; a step of detecting intensities of fluorescence generated at a plurality of locations of the object due to emission of the excitation optical pulse group; and a step of generating a fluorescent image based on the intensities of the fluorescence at the plurality of locations of the object. In the step of generating the excitation optical pulse group, a time interval between the plurality of excitation optical pulses is set to be equal to or shorter than a relaxation time between excited triplet states of the fluorescent dye or to be shorter than 10 picoseconds.

[2] A fluorescence microscope according to one embodiment includes: a pulse group generator that repeatedly generates an excitation optical pulse group including a plurality of excitation optical pulses; an optical system that emits the excitation optical pulse group to an object containing a fluorescent dye; a photodetector that detects intensities of fluorescence generated at a plurality of locations of the object due to emission of the excitation optical pulse group; and a processor that generates a fluorescent image based on the intensities of the fluorescence at the plurality of locations of the object. A time interval between the plurality of excitation optical pulses is set to be equal to or shorter than a relaxation time between excited triplet states of the fluorescent dye or to be shorter than 10 picoseconds.

Photobleaching occurs through the following mechanism. First, an excitation optical pulse is incident on the object and is absorbed by the fluorescent dye. At this time, the fluorescent dye is excited from a ground state S₀ to an excited singlet state (for example, excited state S₁). Thereafter, many molecules return to the ground state S₀ again, thereby generating fluorescence. However, some molecules do not return to the ground state S₀ but transition to an excited triplet state (for example, excited state T₁). This transition is called intersystem crossing. Then, when the next excitation optical pulse is incident on the object and absorbed by the fluorescent dye while the molecule is in the excited triplet state, the molecule transitions to a higher-order excited triplet state (for example, excited state T₂). Photobleaching occurs when the molecule reacts with oxygen while the molecule is in the excited triplet state and accordingly, active oxygen is generated to destroy the molecule. In particular, in the case of a multiphoton excitation microscope using near-infrared light, the molecule in a higher-order excited triplet state (for example, excited state T₂) contributes significantly to photobleaching.

In the image acquisition method according to [1] above and the fluorescence microscope according to [2] above, (a) the time interval between the plurality of excitation optical pulses is equal to or shorter than the relaxation time between excited triplet states of the fluorescent dye, or (b) is shorter than 10 picoseconds. In the case of (a), when the molecule of the fluorescent dye is in a higher-order excited triplet state (for example, excited state T₂), the next excitation optical pulse is incident on the object and absorbed by the fluorescent dye. Therefore, the molecule of the fluorescent dye transitions to an even higher-order excited triplet state (for example, excited state T₃). Then, the potential energy difference between the excited triplet state and the excited singlet state (for example, excited state S₁) of the molecule increases, and the molecule becomes more likely to transition to the excited singlet state before reacting with oxygen. Therefore, destruction of the molecule can be prevented. As a result, photobleaching can be reduced. There are various fluorescent dyes, some of which have a relaxation time between excited triplet states of 10 picoseconds or more. Since the time interval between the plurality of excitation optical pulses is shorter than 10 picoseconds as in (b), it is possible to reduce photobleaching of such fluorescent dyes.

[3] In the image acquisition method according to [1] above or the fluorescence microscope according to [2] above, the relaxation time between excited triplet states of the fluorescent dye may be a relaxation time from an excited state T₂ to an excited state T₁, a so-called T₂ lifetime. In this case, photobleaching can be effectively reduced in a fluorescent dye having a property of transitioning from the excited state T₁ to the excited state T₂ by the excitation optical pulse.

[4] The image acquisition method according to [1] or [3] above may further include a step of inputting information regarding a type of the fluorescent dye before the step of generating the excitation optical pulse group. In the step of generating the excitation optical pulse group, the time interval between the plurality of excitation optical pulses may be set based on the information so as to be equal to or shorter than the relaxation time between excited triplet states of the fluorescent dye. The fluorescence microscope according to [2] or [3] above may further include an information input section for inputting information regarding a type of the fluorescent dye. The pulse group generator may set, based on the information, the time interval between the plurality of excitation optical pulses to be equal to or shorter than the relaxation time between excited triplet states of the fluorescent dye. According to the image acquisition method and the fluorescence microscope, it is possible to set the time interval between the plurality of excitation optical pulses according to the relaxation time of the fluorescent dye used. Therefore, photobleaching of the fluorescent dye can be more effectively reduced.

[5] In the step of generating the excitation optical pulse group in the image acquisition method according to any one of [1], [3], and [4] above, when setting the time interval between the plurality of excitation optical pulses to be shorter than 10 picoseconds, the time interval between the plurality of excitation optical pulses may be set to be shorter than 1 picosecond. Similarly, in the fluorescence microscope according to any one of [2] to [4] above, when the time interval between the plurality of excitation optical pulses is shorter than 10 picoseconds, the time interval between the plurality of excitation optical pulses may be shorter than 1 picosecond. In this case, it is possible to reduce photobleaching of fluorescent dyes with a relaxation time of 1 picosecond or more.

[6] In the step of generating the excitation optical pulse group in the image acquisition method according to any one of [1] and [3] to [5] above, peak intensities of the plurality of excitation optical pulses may be made uniform for each excitation optical pulse group. Similarly, in the fluorescence microscope according to any one of [2] to [5] above, peak intensities of the plurality of excitation optical pulses may be uniform for each excitation optical pulse group. In this case, the peak intensity of the excitation optical pulse when transitioning to a higher-order excited triplet state (for example, excited state T₂) becomes approximately equal to the peak intensity of the excitation optical pulse when transitioning to an even higher-order excited triplet state (for example, excited state T₃). Therefore, the transition from a higher-order excited triplet state to an even higher-order excited triplet state is performed efficiently. As a result, photobleaching of the fluorescent dye can be more effectively reduced.

[7] In the step of generating the excitation optical pulse group in the image acquisition method according to any one of [1] and [3] to [6] above, a repetition frequency for repeatedly generating the excitation optical pulse group may be 1 MHz or more. Similarly, in the fluorescence microscope according to any one of [2] to [6] above, a repetition frequency for repeatedly generating the excitation optical pulse group may be 1 MHz or more. The relaxation time (for example, T₁ lifetime) of the excited triplet state is several microseconds or less for many fluorescent dyes. Therefore, when the repetition frequency of the excitation optical pulse group is 1 MHz or more, in other words, when the time interval between the excitation optical pulse groups is 1 microsecond or less, photobleaching due to the mechanism described above is likely to occur. Therefore, the image acquisition method and the fluorescence microscope described above are useful.

[8] In the fluorescence microscope according to any one of [2] to [7] above, the pulse group generator may include: an excitation light source that repeatedly outputs a single optical pulse; and a waveform controller that is optically coupled to the excitation light source and generates the plurality of excitation optical pulses by modulating the single optical pulse output from the excitation light source. In this case, it is possible to easily configure the pulse group generator that repeatedly generates an excitation optical pulse group including a plurality of excitation optical pulses.

[9] An excitation beam irradiation unit according to one embodiment is an excitation beam irradiation unit used in a fluorescence microscope, and includes a pulse group generator that repeatedly generates an excitation optical pulse group including a plurality of excitation optical pulses to be emitted to an object containing a fluorescent dye. A time interval between the plurality of excitation optical pulses is equal to or shorter than a relaxation time between excited triplet states of the fluorescent dye or shorter than 10 picoseconds. According to this excitation beam irradiation unit, it is possible to reduce photobleaching.

[10] The excitation beam irradiation unit according to [9] above may further include an information input section for inputting information regarding a type of the fluorescent dye. The pulse group generator may set, based on the information, a time interval between the plurality of excitation optical pulses to be equal to or shorter than a relaxation time between excited triplet states of the fluorescent dye. According to this excitation beam irradiation unit, it is possible to set the time interval between a plurality of excitation optical pulses according to the relaxation time of the fluorescent dye used. Therefore, photobleaching of the fluorescent dye can be more effectively reduced.

[11] A waveform control unit according to one embodiment is a waveform control unit for a fluorescence microscope that repeatedly generates an excitation optical pulse group including a plurality of excitation optical pulses to be emitted to an object containing a fluorescent dye. The waveform control unit includes a waveform controller. The waveform controller is optically coupled to an excitation light source that repeatedly outputs a single optical pulse, and generates the plurality of excitation optical pulses by modulating the single optical pulse output from the excitation light source. A time interval between the plurality of excitation optical pulses is equal to or shorter than a relaxation time between excited triplet states of the fluorescent dye or shorter than 10 picoseconds. According to this waveform control unit, it is possible to reduce photobleaching.

[12] The waveform control unit according to [11] above may further include an information input section for inputting information regarding a type of the fluorescent dye. The waveform controller may set, based on the information, the time interval between the plurality of excitation optical pulses to be equal to or shorter than the relaxation time between excited triplet states of the fluorescent dye. According to this waveform control unit, it is possible to set the time intervals between a plurality of excitation optical pulses according to the relaxation time of the fluorescent dye used. Therefore, photobleaching of the fluorescent dye can be more effectively reduced.

### Advantageous Effects of Invention

According to the present disclosure, it is possible to provide an image acquisition method, a fluorescence microscope, an excitation beam irradiation unit, and a waveform control unit that can reduce photobleaching.

### BRIEF DESCRIPTION OF DRAWINGS

FIG. 1 is a diagram showing the configuration of a fluorescence microscope according to an embodiment.

FIG. 2 is a drawing schematically showing a time waveform of excitation beam. (a) schematically shows a time waveform of excitation beam output from an excitation light source. (b) schematically shows a time waveform of excitation beam output from a waveform controller.

FIG. 3 is a drawing showing a specific configuration example of the waveform controller.

FIG. 4 is a drawing showing a modulation surface of a spatial light modulator (SLM).

FIG. 5 is a graph showing an example of excitation beam. (a) shows a spectral waveform of single-pulse excitation beam. (b) shows a time intensity waveform of the excitation beam.

FIG. 6 is a graph showing an example of excitation beam. (a) shows a spectral waveform of excitation beam when rectangular wave-shaped phase spectral modulation is applied in the SLM. (b) shows a time intensity waveform of the excitation beam.

FIG. 7 is a drawing showing a specific configuration example of a fluorescence microscope.

FIG. 8 is a flowchart showing an image acquisition method according to an embodiment.

FIG. 9 is a graph showing the time waveforms of an optical pulse and an optical pulse group. (a) to (d) show the time waveforms of a single optical pulse, an optical pulse group including four optical pulses, an optical pulse group including nine optical pulses, and an optical pulse group including 16 optical pulses, respectively.

FIG. 10 is a graph showing the dependence of the photobleaching rate on the excitation beam intensity. (a) shows a graph for Eosin Y, (b) shows a graph for Fluorescein, and (c) shows a graph for C-Naphox-TEG.

FIG. 11 is a graph showing the dependence of the photobleaching rate on the number of pulses (N). (a) shows a graph for Eosin Y, (b) shows a graph for Fluorescein, and (c) shows a graph for C-Naphox-TEG.

FIG. 12 is a graph showing a relationship between the excitation beam intensity and the photobleaching rate. (a) shows a relationship between the average intensity (I_{N}/√N) of excitation beam and a photobleaching rate P_{N}. (b) shows a case where the photobleaching rate P_{N} is normalized with a photobleaching rate P₁ of N=1 in the graph shown in (a).

FIG. 13 is a drawing showing a mechanism by which photobleaching occurs.

FIG. 14 is a graph showing the dependence of the photobleaching rate on the number of pulses (N). (a) to (c) show graphs including the same plots as in the graphs shown in (a) to part (c) in FIG. 11, respectively. However, curves show theoretical values calculated based on the mechanism shown in FIG. 13, unlike the curves shown in FIG. 11.

FIG. 15 is a graph showing the theoretical relationship based on the mechanism shown in FIG. 13 between the average intensity (I_{N}/√N) of excitation beam and a value (P_{N}/P₁) obtained by normalizing the photobleaching rate P_{N} with a photobleaching rate P₁ of N=1.

FIG. 16 is a graph showing the results of calculation of the relationship between the time interval between optical pulses and the photobleaching rate.

FIG. 17 is a graph showing the time waveforms of five types of optical pulse groups with different uniformities of peak intensity.

FIG. 18 is a graph showing the results of measurement of the color fading rate when a fluorescent dye is irradiated with the five types of optical pulse groups shown in parts (a) to (e) in FIG. 17. FIG. 18 shows a relationship between the ratio (σ/μ) and the color fading rate.

FIG. 19 is a diagram showing the configuration of a modulation pattern calculation device.

FIG. 20 is a diagram schematically showing an example of the hardware configuration of the modulation pattern calculation device.

FIG. 21 is a drawing showing a procedure for calculating a phase spectrum using an iterative Fourier method.

FIG. 22 is a drawing showing a procedure for calculating a phase spectrum using the iterative Fourier method.

FIG. 23 is a drawing showing a procedure for calculating a phase spectrum.

FIG. 24 is a drawing showing a procedure for calculating a phase spectrum using the iterative Fourier method.

FIG. 25 is a drawing showing an example of a weighting function We(t) when Target₀(t) is a multipulse.

FIG. 26 is a drawing showing a calculation procedure in an iterative Fourier transform unit of an intensity spectrum design unit.

FIG. 27 is a flowchart showing a modulation pattern calculation method.

FIG. 28 is a drawing showing a procedure for calculating a phase spectrum using the iterative Fourier method.

FIG. 29 is a drawing showing a procedure for calculating a phase spectrum using the iterative Fourier method.

FIG. 30 is a diagram showing an excitation beam irradiation unit used in a fluorescence microscope.

FIG. 31 is a diagram showing a waveform control unit used in a fluorescence microscope.

### DESCRIPTION OF EMBODIMENTS

Hereinafter, embodiments of the present disclosure will be described in detail with reference to the accompanying drawings. In the description of the drawings, the same elements are denoted by the same reference numerals, and the repeated description thereof will be omitted.

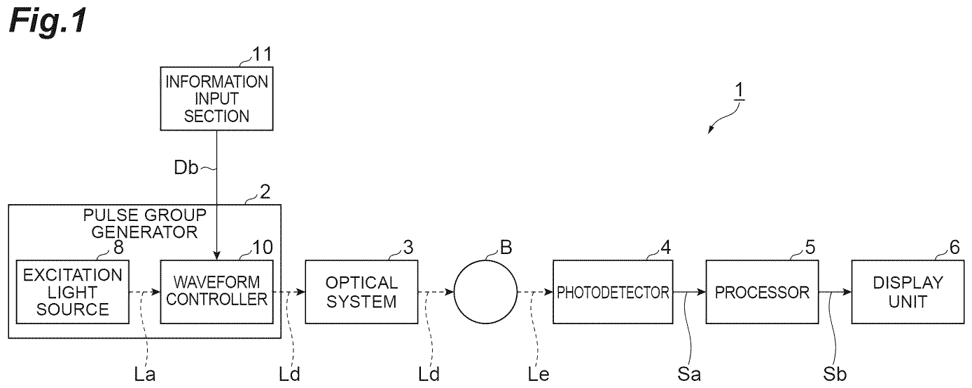

FIG. 1 is a diagram showing the configuration of a fluorescence microscope 1 according to an embodiment. The fluorescence microscope 1 is a device that obtains a fluorescent image by irradiating an object B, which is an observation target, with excitation beam Ld and detecting fluorescence Le generated from the object B due to the irradiation. As shown in FIG. 1, the fluorescence microscope 1 according to the present embodiment includes a pulse group generator 2, an optical system 3, a photodetector 4, a processor 5, a display unit 6, and an information input section 11. The pulse group generator 2 includes an excitation light source 8 and a waveform controller 10.

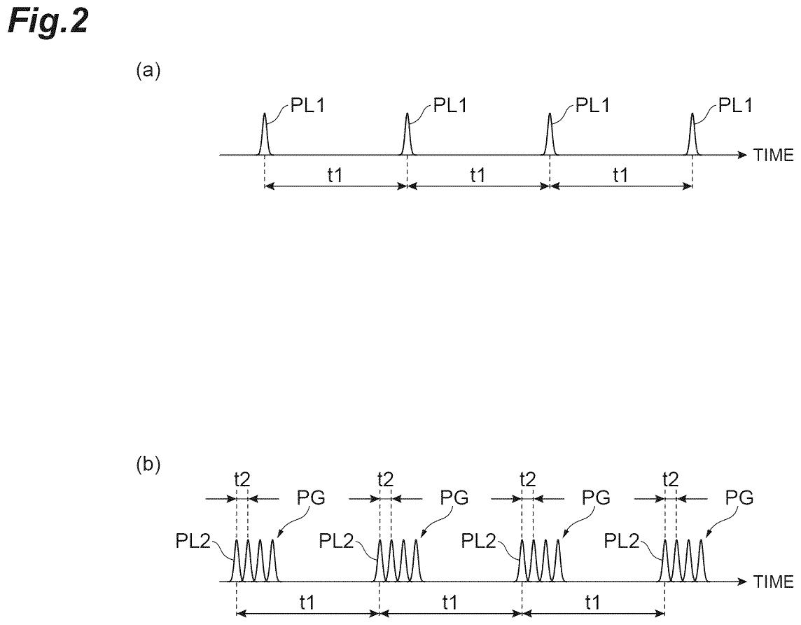

The excitation light source 8 is optically coupled to the waveform controller 10, and provides excitation beam La to the waveform controller 10. Part (a) in FIG. 2 is a drawing schematically showing the time waveform of the excitation beam La output from the excitation light source 8. As shown in part (a) in FIG. 2, the excitation beam La includes a repetition of a single optical pulse PL1. The repetition period t1 of the optical pulse PL1 is, for example, 1 nanosecond or more and 10 microseconds or less or 10 nanoseconds or more and 100 nanoseconds or less. In other words, the repetition frequency of the optical pulse PL1 is, for example, 0.1 MHz or more and 1 GHz or less or 10 MHz or more and 100 MHz or less. In one example, the repetition frequency of the optical pulse PL1 is 80 MHz. The repetition period t1 of the optical pulse PL1 may be fixed. The repetition period t1 of the optical pulse PL1 can be defined as a peak interval of the optical pulse PL1. The full width at half maximum (FWHM) of the optical pulse PL1 is, for example, 5 femtoseconds or more and 200 femtoseconds or less or 30 femtoseconds or more and 200 femtoseconds or less. The excitation light source 8 repeatedly outputs such a single optical pulse PL1. The excitation light source 8 is a laser light source such as a solid-state laser light source, a gas laser light source, a semiconductor laser light source, or a fiber laser light source. The excitation beam La is, for example, coherent light.

The waveform controller 10 converts the excitation beam La provided from the excitation light source 8 into the excitation beam Ld. The excitation beam Ld is output from the pulse group generator 2. Part (b) in FIG. 2 is a drawing schematically showing the time waveform of the excitation beam Ld output from the waveform controller 10. As shown in part (b) in FIG. 2, the excitation beam Ld includes a repetition of an excitation optical pulse group PG (hereinafter, referred to as an optical pulse group PG). The repetition period t1 of the optical pulse group PG is the same as the repetition period t1 of the optical pulse PL1 and is, for example, 1 nanosecond or more and 10 microseconds or less or 10 nanoseconds or more and 100 nanoseconds or less. In other words, the repetition frequency of the optical pulse group PG is, for example, 0.1 MHz or more and 1 GHz or less or 10 MHz or more and 100 MHz or less. The optical pulse group PG includes a plurality of excitation optical pulses PL2 (hereinafter, referred to as optical pulses PL2) arranged at time intervals t2. In one example, the time interval t2 between the plurality of optical pulses PL2 is fixed for each optical pulse group PG. The peak intensity of the optical pulse PL2 is uniform for each optical pulse group PG. The repetition period t1 of the optical pulse group PG can be defined as a peak interval of the leading optical pulse PL2 among the plurality of optical pulses PL2 forming each optical pulse group PG. The time interval t2 can be defined as a peak interval of the optical pulse PL2. The full width at half maximum (FWHM) of the optical pulse PL2 is, for example, 5 femtoseconds or more and 200 femtoseconds or less or 30 femtoseconds or more and 200 femtoseconds or less.

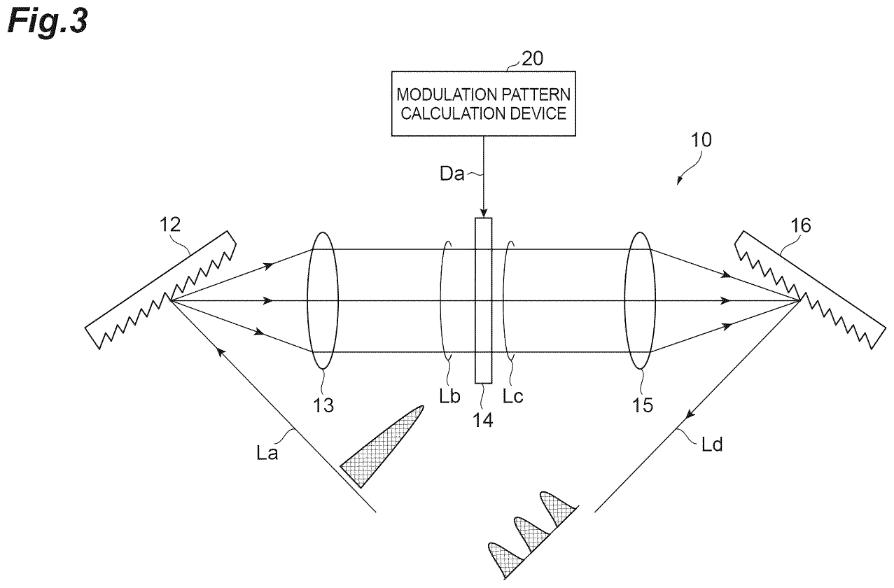

FIG. 3 is a drawing showing a specific configuration example of the waveform controller 10. In the example shown in FIG. 3, the waveform controller 10 includes a diffraction grating 12, a lens 13, a spatial light modulator (SLM) 14, a lens 15, a diffraction grating 16, and a modulation pattern calculation device 20. The diffraction grating 12 is an example of a spectroscopic element, and is optically coupled to the excitation light source 8. The SLM 14 is optically coupled to the diffraction grating 12 through the lens 13. The diffraction grating 12 splits the excitation beam La into individual wavelength components. As spectroscopic elements, other optical components such as a prism may be used instead of the diffraction grating 12. The spectroscopic element may be of a reflective type or a transmissive type. The excitation beam La is obliquely incident on the diffraction grating 12 to be split into a plurality of wavelength components. Beam Lb including a plurality of wavelength components is condensed by the lens 13 for each wavelength component, and an image is formed on the modulation surface of the SLM 14. The lens 13 may be a convex lens formed of a light transmissive material, or may be a concave mirror having a concave light reflecting surface. In addition, the lens 15 may be a cylindrical lens.

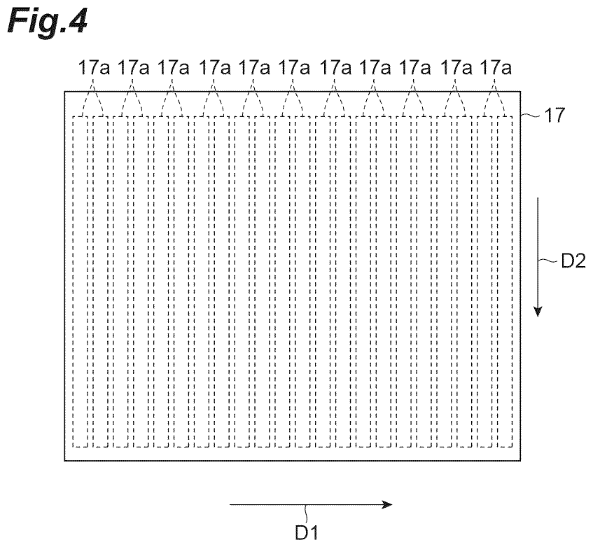

The SLM 14 simultaneously performs phase modulation and intensity modulation of the beam Lb in order to generate the excitation beam Ld having an arbitrary time intensity waveform different from that of the excitation beam La. The SLM 14 may perform only the intensity modulation. The SLM 14 is, for example, of a phase modulation type. In a practical example, the SLM 14 is of an LCOS (Liquid crystal on silicon) type. Alternatively, the SLM 14 may be an intensity modulation type SLM, such as a digital micromirror device (DMD). The SLM 14 may be of a reflective or transmissive type. FIG. 4 is a drawing showing a modulation surface 17 of the SLM 14. As shown in FIG. 4, on the modulation surface 17, a plurality of modulation regions 17a are arranged along a direction D1, and each modulation region 17a extends in a direction D2 crossing the direction D1. The direction D1 is a spectroscopic direction by the diffraction grating 12. The modulation surface 17 functions as a Fourier transform surface, and each corresponding wavelength component after splitting is incident on each of the plurality of modulation regions 17a. The SLM 14 modulates the phase and intensity of each incident wavelength component in each modulation region 17a independently of the other wavelength components. When the SLM 14 is of the phase modulation type, the intensity modulation is realized by a phase pattern (phase image) presented on a modulation surface 17.

The SLM 14 is electrically connected to the modulation pattern calculation device 20. The modulation pattern calculation device 20 calculates a modulation pattern to be presented by the SLM 14, and provides data Da indicating the modulation pattern to the SLM 14. The modulation pattern is, for example, Computer-Generated Holograms (CGH).

Each wavelength component of modulated beam Lc modulated by the SLM 14 is focused at one point on the diffraction grating 16 by the lens 15. The lens 15 at this time functions as a condensing optical system that condenses the modulated beam Lc. The lens 15 may be a convex lens formed of a light transmissive member, or may be a concave mirror having a concave light reflecting surface. In addition, the lens 15 may be a cylindrical lens. The diffraction grating 16 functions as a multiplexing optical system, and multiplexes a plurality of wavelength components after modulation. That is, a plurality of wavelength components of the modulated beam Lc are condensed and multiplexed by the lens 15 and the diffraction grating 16 to form the excitation beam Ld.

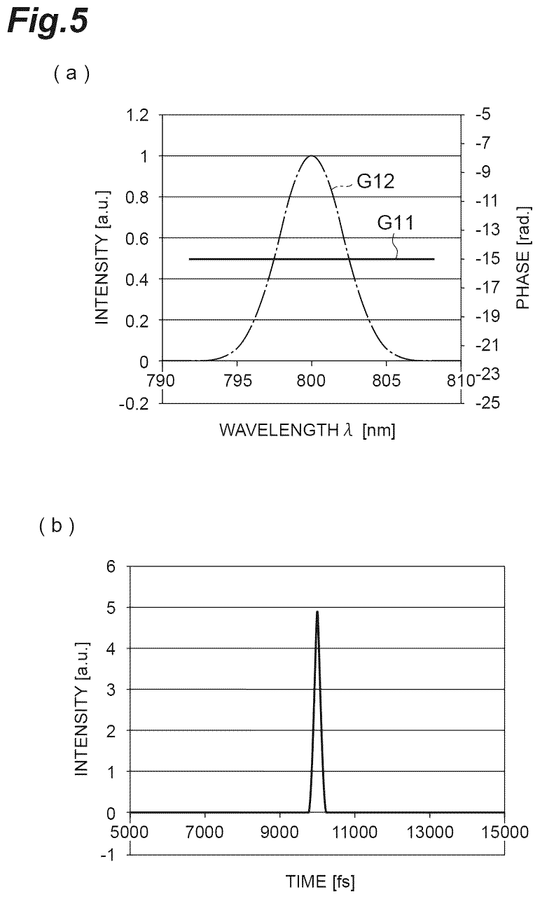

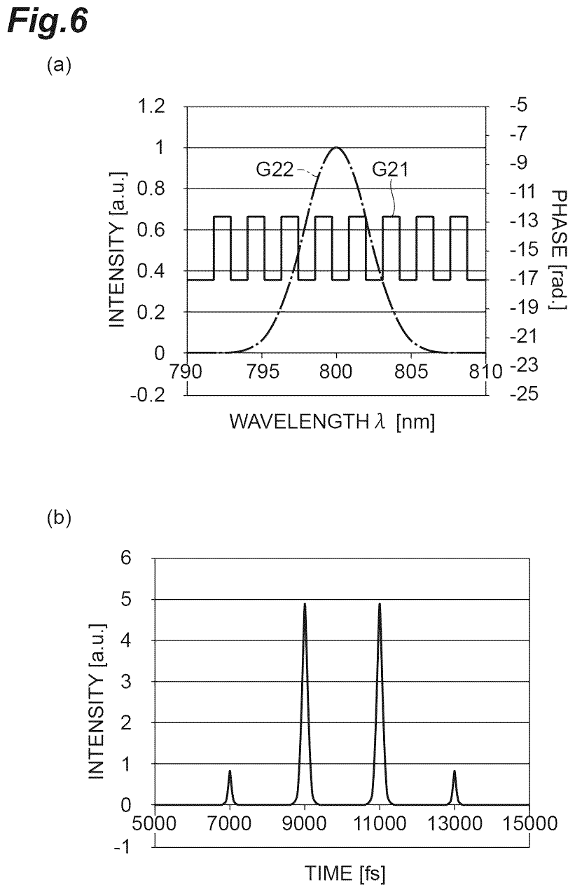

A region in front of the lens 15 (spectral domain) and a region behind the diffraction grating 16 (time domain) have a Fourier transform relationship therebetween. Therefore, phase modulation and intensity modulation in the spectral domain affects the time intensity waveform in the time domain. Therefore, the excitation beam Ld has a desired time intensity waveform, which is different from that of the excitation beam La, according to the modulation pattern of the SLM 14. Here, part (a) in FIG. 5 shows, as an example, a spectral waveform (spectral phase G11 and spectral intensity G12) of the single-pulse excitation beam La, and part (b) in FIG. 5 shows a time intensity waveform of the excitation beam La. Part (a) in FIG. 6 shows, as an example, a spectral waveform (spectral phase G21 and spectral intensity G22) of the excitation beam Ld when rectangular wave-shaped phase spectral modulation is applied in the SLM 14, and part (b) in FIG. 6 shows a time intensity waveform of the excitation beam Ld. In part (a) in FIG. 5 and part (a) in FIG. 6, the horizontal axis indicates wavelength (nm), the left vertical axis indicates the intensity value (arbitrary unit) of the intensity spectrum, and the right vertical axis indicates the phase value (rad) of the phase spectrum. In part (b) in FIG. 5 and part (b) in FIG. 6, the horizontal axis indicates time (femtoseconds), and the vertical axis indicates light intensity (arbitrary unit). In this example, by applying a rectangular wave-shaped phase spectrum waveform to the excitation beam Ld, a single optical pulse PL1 of the excitation beam La is converted into the optical pulse group PG including a plurality of optical pulses PL2. The spectra and waveforms shown in FIGS. 5 and 6 are examples, and the number of optical pulses PL2 in the optical pulse group PG, the pulse width and the peak intensity of the optical pulse PL2, and the time interval t2 between the optical pulses PL2 can be controlled in various ways by combining various spectral phases and spectral intensities.

FIG. 1 is referred to again. The excitation beam Ld including the optical pulse group PG output from the pulse group generator 2 is input to the optical system 3. The optical system 3 irradiates the object B, which is an observation target, with the excitation beam Ld. The object B is pre-stained with a fluorescent dye. The fluorescent dye contains at least one material selected from the group including, for example, a methanol solution of Eosin Y, an aqueous solution of Eosin Y, a methanol solution of Rose Bengal, an ethanol solution of Rhodamine 6G, an aqueous solution of Rose Bengal, Rhodamine 6G, and anthracene. The object B may be a biological molecule or biological tissue that has been genetically engineered to emit fluorescence.

The fluorescent dye in the object B is excited by emission of the excitation beam Ld including the optical pulse group PG, thereby generating the fluorescence Le at a plurality of locations of the object B. At this time, the fluorescent dye in the object B may generate the fluorescence Le by multiphoton absorption (for example, two-photon absorption). For example, by irradiating the object B with the optical pulse PL2 having an extremely short pulse width, such as on the order of picoseconds or femtoseconds, the photon density of the excitation beam Ld can be increased to cause multiphoton absorption. The fluorescence Le is input to the photodetector 4. The photodetector 4 detects the intensity of the fluorescence Le at each location of the object B. The photodetector 4 is, for example, a semiconductor light receiving element such as a photodiode, an avalanche photodiode, or a single photon avalanche diode, or a photomultiplier tube. The photodetector 4 generates an electrical signal Sa according to the intensity of the fluorescence Le. The photodetector 4 provides the generated electrical signal Sa to the processor 5.

The processor 5 is electrically connected to the photodetector 4, and receives the electrical signal Sa from the photodetector 4. The processor 5 generates data Sb regarding a fluorescent image of the object B based on the intensities of the fluorescence Le at plurality of locations of the object B. The processor 5 provides the data Sb to the display unit 6. The display unit 6 displays the fluorescent image of the object B based on the data Sb. The processor 5 is a personal computer, a smart device such as a smartphone or a tablet terminal, or a computer such as a cloud server. A computer as the processor 5 includes an HDD, a storage device such as a flash memory or a RAM, and a processor (CPU). The processor 5 may be configured by using a microcomputer or an FPGA (Field-Programmable Gate Array).

The time interval t2 between the optical pulses PL2 shown in part (b) in FIG. 2 is set by the modulation pattern calculation device 20 so as to be equal to or shorter than the relaxation time between excited triplet states (for example, the relaxation time from excited state T₂ to excited state T₁, that is, T₂ lifetime) of the fluorescent dye or shorter than 10 picoseconds, as will be described in detail later. When the time interval t2 is shorter than 10 picoseconds, the time interval t2 may be shorter than 6 picoseconds, shorter than 3 picoseconds, or shorter than 1 picosecond. The T₂ lifetime of the fluorescent dye mentioned above is as follows.
Methanol solution of Eosin Y: 1 picosecond
Aqueous solution of Eosin Y: 1 picosecond
Methanol solution of Rose Bengal: 2.2 picoseconds
Ethanol solution of Rhodamine 6G: 2 picoseconds
Rose Bengal: 5.8 picoseconds
Aqueous solution of Rhodamine 6G: 0.2 picoseconds
Anthracene: 11 picoseconds

The information input section 11 inputs information regarding the type of fluorescent dye in the object B. The information input section 11 inputs information regarding the type of fluorescent dye in the object B, for example, through an input operation by the user of the fluorescence microscope 1. The information input section 11 is, for example, an input device such as a keyboard or a touch panel. The information input section 11 provides information Db regarding the type of fluorescent dye in the object B to the modulation pattern calculation device 20. Based on the information Db, the modulation pattern calculation device 20 sets the time interval t2 between the optical pulses PL2 to be equal to or shorter than the relaxation time between excited triplet states of the fluorescent dye.

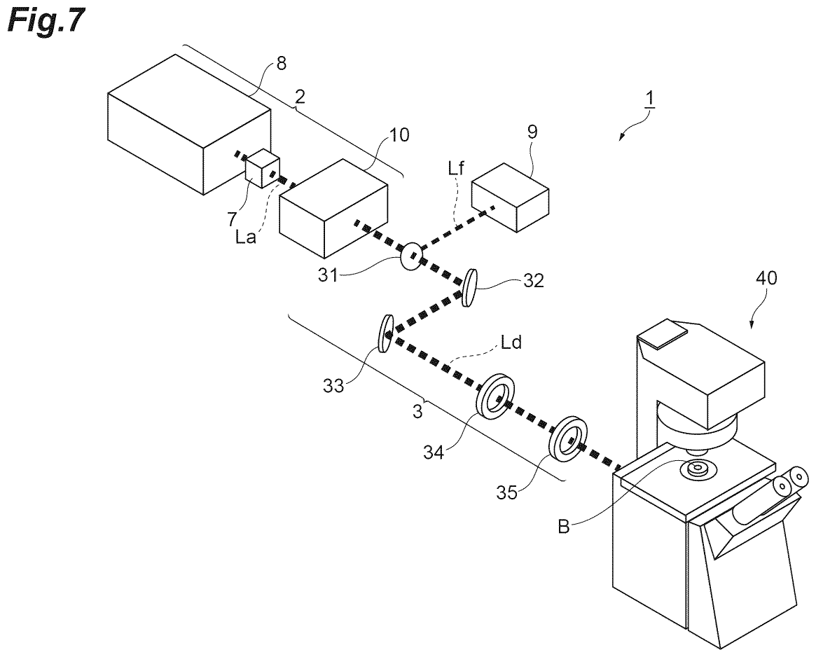

FIG. 7 is a drawing showing a specific configuration example of the fluorescence microscope 1. In the example shown in FIG. 7, the fluorescence microscope 1 further includes an intensity controller 7 and a waveform measuring device 9. The optical system 3 includes a beam splitting element 31, galvanometer mirrors 32 and 33, and coupling lenses 34 and 35.

The intensity controller 7 is arranged on the optical path of the excitation beam La between the excitation light source 8 and the waveform controller 10. The intensity controller 7 adjusts the light intensity of the excitation beam La by attenuating the excitation beam La. The intensity controller 7 includes at least one optical element of, for example, an acousto-optic modulator (AOM), an electro-optic modulator (EOM), and a combination of a half-wave plate and a polarizer.

The beam splitting element 31 is arranged on the optical axis of the excitation beam Ld output from the waveform controller 10. The beam splitting element 31 separates excitation beam Lf, which is a part of the excitation beam Ld, from the excitation beam Ld. The excitation beam Lf is input to the waveform measuring device 9. The waveform measuring device 9 measures the time waveform of the excitation beam Ld by measuring the time waveform of the excitation beam Lf. The waveform measuring device 9 may include a phase-to-phase measuring device formed by a nonlinear crystal, a delay stage, and a spectrometer. Alternatively, the waveform measuring device 9 may include an interferometer formed by a spectrometer. The measurement result of the waveform measuring device 9 is provided to the modulation pattern calculation device 20 in the waveform controller 10. The modulation pattern calculation device 20 controls the modulation pattern presented in the SLM 14 so that the time waveform of the excitation beam Ld measured by the waveform measuring device 9 approximates a desired time waveform (specifically, the number of optical pulses PL2 in the optical pulse group PG, the pulse width and the peak intensity of the optical pulse PL2, and the time interval t2 between the optical pulses PL2).

The galvanometer mirrors 32 and 33 are optical elements for scanning the optical axis of the excitation beam Ld. The galvanometer mirror 32 is optically coupled to the waveform controller 10 through the beam splitting element 31, and moves the optical axis of the excitation beam Ld in one direction perpendicular to the optical axis of the excitation beam Ld. The galvanometer mirror 33 is optically coupled to the galvanometer mirror 32, and moves the optical axis of the excitation beam Ld in another direction perpendicular to both the optical axis of the excitation beam Ld and the one direction described above. The coupling lenses 34 and 35 are optical elements for optically coupling the excitation beam Ld, whose optical axis moves, with the object B. The coupling lens 34 is optically coupled to the galvanometer mirror 33, and the coupling lens 35 is optically coupled to the coupling lens 34.

The excitation beam Ld is input to a microscope body 40. The microscope body 40 has a placement table on which the object B is placed, and the above-described photodetector 4, processor 5, and display unit 6 are built in the microscope body 40. The object B placed on the placement table is irradiated with the excitation beam Ld from below. The fluorescence Le generated in the object B is incident on the photodetector 4 through an objective lens (not shown) arranged below the object B.

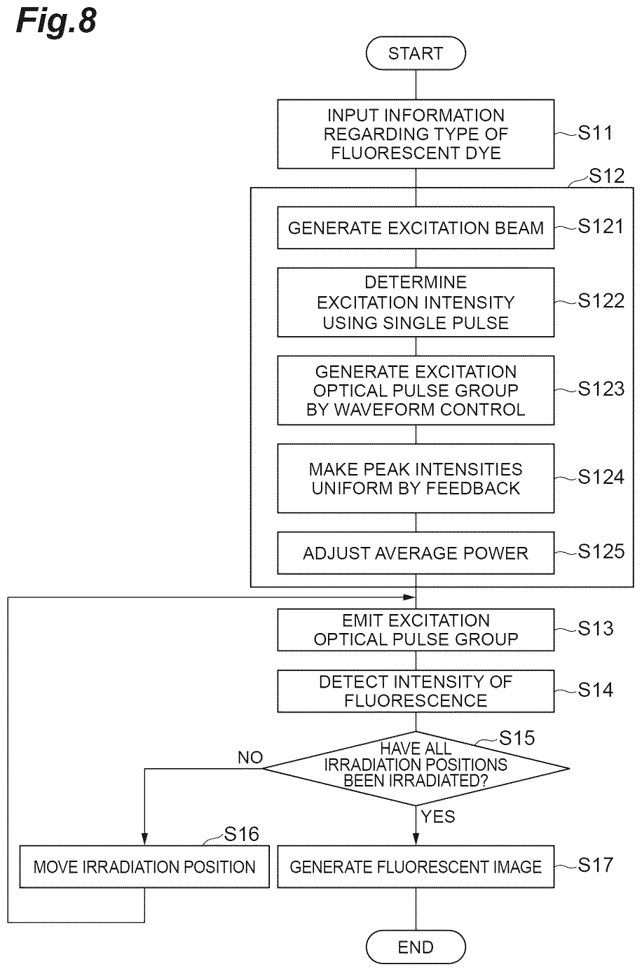

FIG. 8 is a flowchart showing an image acquisition method according to the present embodiment. This image acquisition method can also be regarded as a method of operating the fluorescence microscope 1 described above. First, in step S11, the information input section 11 inputs the information Db regarding the type of fluorescent dye. Then, in step S12, the pulse group generator 2 repeatedly generates the optical pulse group PG including a plurality of optical pulses PL2. In this step S12, first, the excitation light source 8 repeatedly outputs a single optical pulse PL1 (step S121). Then, the optical pulse PL1 is directly emitted to the object B, and the fluorescence intensity is detected by the photodetector 4. Based on the detection result, the sensitivity of the photodetector 4, the detection limit based on the S/N, and the like are checked to determine the intensity I₁ of the excitation beam (step S122). Then, the waveform controller 10 modulates the optical pulse PL1 output from the excitation light source 8, and repeatedly outputs the optical pulse group PG including N (N is an integer of 2 or more) optical pulses PL2 (step S123). At this time, the waveform controller 10 sets the time interval t2 between the optical pulses PL2 to be equal to or shorter than the relaxation time between excited triplet states (for example, the relaxation time from excited state T₂ to excited state T₁, that is, T₂ lifetime) of the fluorescent dye in the object B or to be shorter than 10 picoseconds. When the time interval t2 is shorter than 10 picoseconds, the time interval t2 may be shorter than 5 picoseconds, shorter than 3 picoseconds, or shorter than 1 picosecond. Based on the information Db regarding the type of fluorescent dye obtained in step S11, the waveform controller 10 sets the time interval t2 between the optical pulses PL2 to be equal to or shorter than the relaxation time between excited triplet states of the fluorescent dye.

Then, based on the time waveform of the excitation beam Ld (that is, the optical pulse group PG) measured by the waveform measuring device 9, the modulation pattern calculation device 20 of the waveform controller 10 controls the modulation pattern of the SLM 14 so that the peak intensity of the optical pulse PL2 is uniform for each optical pulse group PG (step S124). Then, the average power of the excitation beam Ld is made to approach (√N)√I₁ by using the intensity controller 7 (step S125).

Then, in step S13, the optical system 3 irradiates the object B containing a fluorescent dye with the excitation beam Ld including the optical pulse group PG. Then, in step S14, the photodetector 4 detects the intensity of the fluorescence Le generated by the fluorescent dye in the object B due to the emission of the excitation beam Ld. Here, it is determined whether or not all irradiation positions have been irradiated with the excitation beam Ld (step S15). If there is an irradiation position that is not irradiated with the excitation beam Ld (step S15: NO), the galvanometer mirrors 32 and 33 move the optical axis of the excitation beam Ld (step S16), and the fluorescence microscope 1 repeats the operations from step S13. When all the irradiation positions have been irradiated with the excitation beam Ld (step S15: YES), the fluorescence microscope 1 performs the operation of step S17. In step S17, the processor 5 generates a fluorescent image based on the intensities of the fluorescence Le at a plurality of locations, that is, at all irradiation positions, of the object B. Thereafter, the display unit 6 receives the data Sb regarding the fluorescent image from the processor 5 and displays the fluorescent image.

The function and effect obtained by the above-described fluorescence microscope 1 and image acquisition method according to the present embodiment will be described.

For example, in a multiphoton excitation fluorescence microscope, pulsed excitation beam is emitted to an object. However, if the fluorescence is continuously detected while emitting the pulsed excitation beam, the fluorescence intensity gradually decreases. This phenomenon is called photobleaching. Since photobleaching limits the object observation time, it is desirable to reduce the photobleaching in the fluorescence microscope.

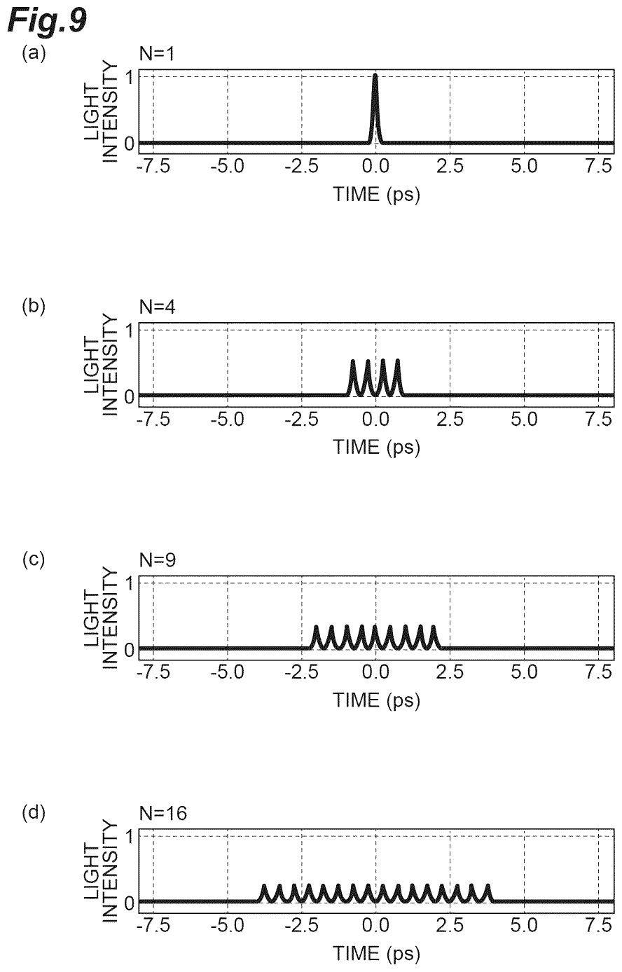

The aforementioned Non Patent Literature 1 discloses that emitting an optical pulse group including a plurality of optical pulses reduces the photobleaching rate compared to emitting a single optical pulse. In addition, Non Patent Literature 1 discloses, from theoretical considerations, that when an observation target, whose photobleaching rate is proportional to the cube of the peak energy of the optical pulse, is irradiated with an optical pulse group including N optical pulses, the photobleaching rate may be reduced by a factor of (1/√N). In order to check the effect of the method described in Non Patent Literature 1, the present inventors conducted the following experiments. First, as shown in FIG. 9, a single optical pulse (that is, N=1, see part (a) in FIG. 9), an optical pulse group including four optical pulses (that is, N=4, see part (b) in FIG. 9), an optical pulse group including nine optical pulses (that is, N=9, see part (c) in FIG. 9), and an optical pulse group including 16 optical pulses (that is, N=16, see part (d) in FIG. 9) were generated. Then, these optical pulses and optical pulse groups were emitted to three types of fluorescent dyes (eosin Y, fluorescein, and C-Naphox-TEG) to examine the dependence of the photobleaching rate on the excitation beam intensity and the number of pulses (N).

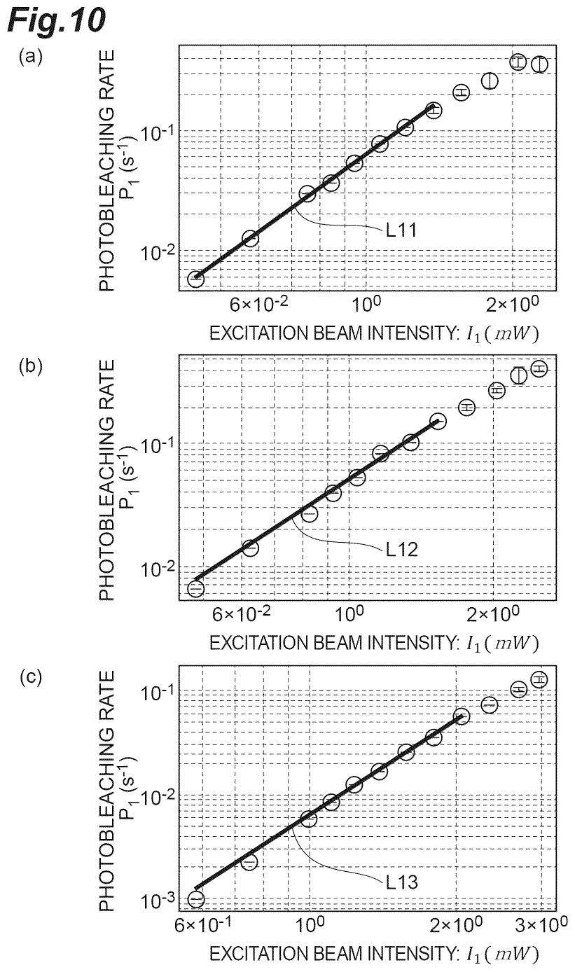

FIG. 10 is a graph showing the dependence of the photobleaching rate on the excitation beam intensity. Part (a) in FIG. 10 shows a graph for Eosin Y, (b) shows a graph for Fluorescein, and (c) shows a graph for C-Naphox-TEG. Straight lines L11 to L13 are approximate straight lines of these graphs. From these approximate straight lines L11 to L13, it was found that the photobleaching rate for eosin Y was proportional to the 2.93 power of the excitation beam intensity, the photobleaching rate for fluorescein was proportional to the 2.66 power of the excitation beam intensity, and the photobleaching rate for C-Naphox-TEG was proportional to the 3.08 power of the excitation beam intensity.

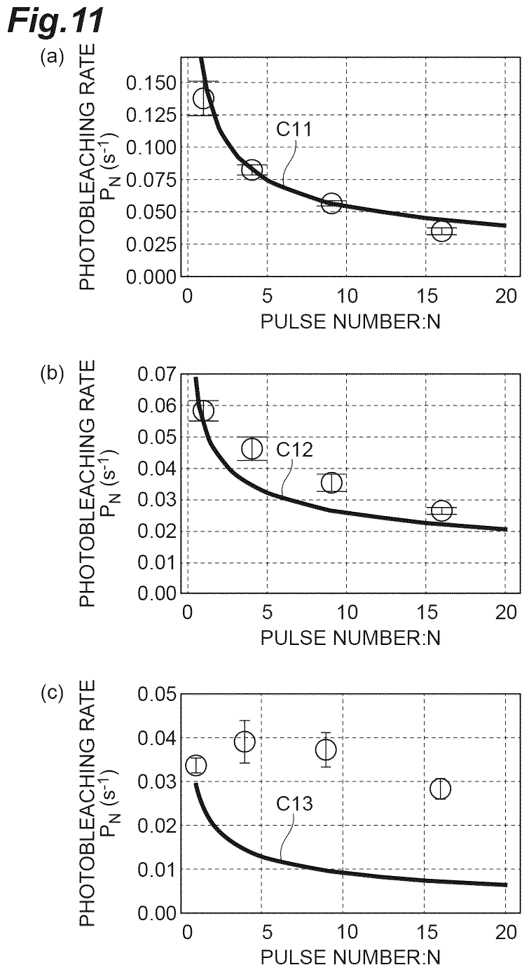

FIG. 11 is a graph showing the dependence of the photobleaching rate on the number of pulses (N). Part (a) in FIG. 11 shows a graph for Eosin Y, (b) shows a graph for Fluorescein, and (c) shows a graph for C-Naphox-TEG. Curves C11 to C13 show theoretical values based on the above-described respective exponents calculated from the graph in FIG. 10. Referring to part (a) in FIG. 11, the dependence of the photobleaching rate on the number of pulses (N) for Eosin Y almost matches the theoretical value. However, referring to part (b) in FIG. 11, it can be seen that the dependence of the photobleaching rate on the number of pulses (N) for fluorescein deviates from the theoretical value. Referring to part (c) in FIG. 11, it can be seen that the dependence of the photobleaching rate on the number of pulses (N) for C-Naphox-TEG deviates even more from the theoretical value. Thus, the inventors' experiments have revealed that the theory described in Non Patent Literature 1 does not hold true depending on the type of fluorescent dye.

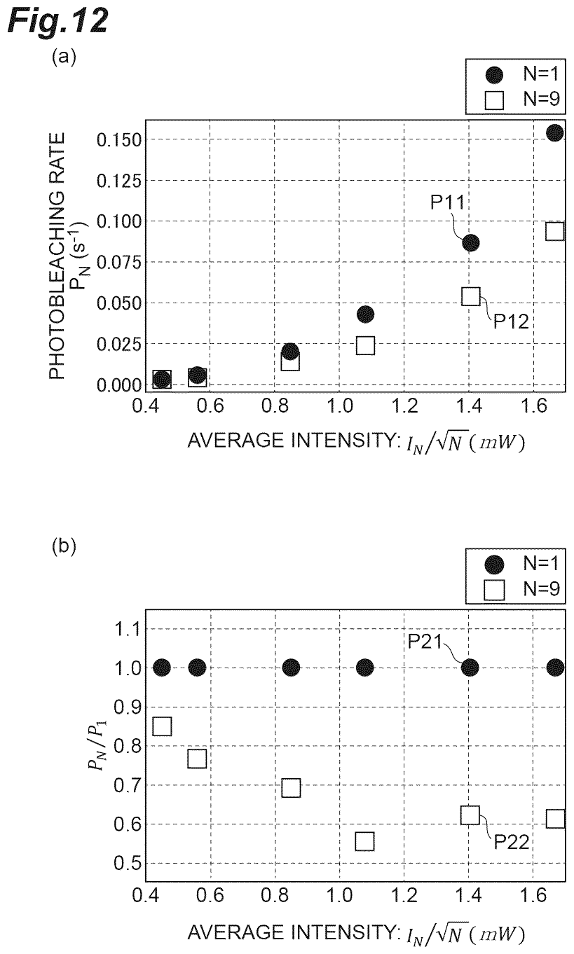

The inventors examined a change in photobleaching rate due to changes in the excitation beam intensity for a single optical pulse (N=1, see part (a) in FIG. 9) and an optical pulse group including nine optical pulses (N=9, see part (c) in FIG. 9). Part (a) in FIG. 12 is a graph showing the relationship between the average intensity (I_{N}/√N) of the excitation beam and a photobleaching rate P_{N}. In the drawing, plot p11 shows a case of N=1, and plot p12 shows a case of N=9. Part (b) in FIG. 12 shows a case where the photobleaching rate P_{N} is normalized with a photobleaching rate P₁ when N=1 in the graph shown in part (a) in FIG. 12. In the drawing, plot P21 shows a case of N=1, and plot P22 shows a case of N=9.

According to the theory described in Non Patent Literature 1, in the graph shown in part (b) in FIG. 12, the standard value (P_{N}/P₁) of the photobleaching rate when N=9 should be constant regardless of the average intensity of the excitation beam. However, the standard value (P_{N}/P₁) of the photobleaching rate when N=9 gradually decreases as the average intensity of the excitation beam increases. That is, it can be said that the higher the excitation beam intensity, the greater the effect of reducing the photobleaching rate. This phenomenon cannot be explained by the theory described in Non Patent Literature 1.

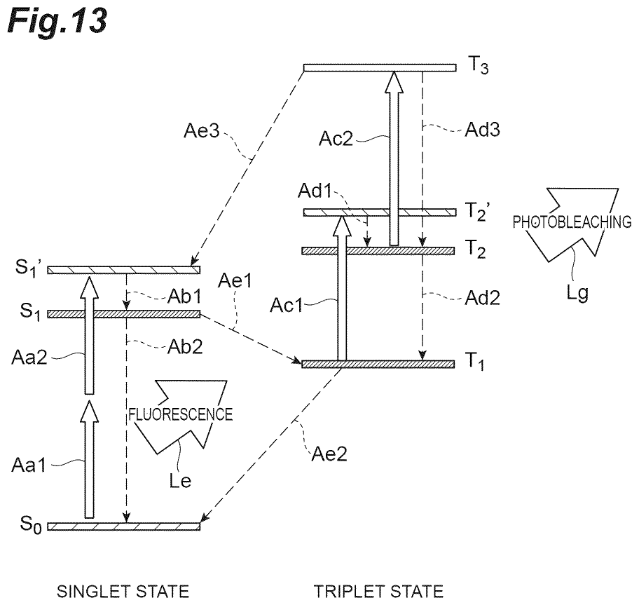

FIG. 13 is a drawing showing a mechanism by which photobleaching occurs. Photobleaching occurs through the following mechanism. First, an excitation optical pulse is incident on an object and is absorbed by the fluorescent dye. At this time, the fluorescent dye is excited from a ground state S₀ to an excited singlet state (for example, excited state S₁) (arrows Aa1 and Aa2 in the drawing). FIG. 13 illustrates a case of two-photon absorption. More specifically, the fluorescent dye is first excited to a state S₁′, which has a higher potential than the excited state S₁. Then, the fluorescent dye quickly transitions to the excited state S₁, in which the vibration level is zero, due to vibration energy relaxation (arrow Ab1 in the drawing). Thereafter, many molecules return to the ground state S₀ again (arrow Ab2 in the drawing), thereby generating the fluorescence Le. However, some molecules do not return to the ground state S₀ but transition to an excited triplet state (for example, the excited state T₁), that is, undergo intersystem crossing (arrow Ae1 in the drawing). Then, when the time interval between excitation optical pulses becomes longer than the relaxation time (T₁ lifetime) from the excited triplet state, some molecules return to the ground state S₀ (arrow Ae2 in the drawing). However, when the time interval between excitation optical pulses becomes shorter than the relaxation time from the excited triplet state (T₁ lifetime), the next excitation optical pulse is incident on the object during the excited triplet state and absorbed by the fluorescent dye. As a result, the molecules transition to a higher-order excited triplet state (for example, the excited state T₂) (arrow Ac1 in the drawing). More specifically, the fluorescent dye is first excited to a state T₂′, which has a higher potential than the excited state T₂. Then, the fluorescent dye quickly transitions to the excited state T₂, in which the vibration level is zero, due to vibration energy relaxation (arrow Ad1 in the drawing). Then, when the molecules are in such a higher-order excited triplet state, the molecules react with oxygen to generate active oxygen, and accordingly, the molecules are destroyed to cause photobleaching (arrow Lg in the drawing). Molecules that do not react with oxygen return to the excited state T₁ again (arrow Ad2 in the drawing).

In the image acquisition method and the fluorescence microscope 1 according to the present embodiment, the time interval t2 between a plurality of optical pulses PL2 is set to be equal to or shorter than the relaxation time between excited triplet states of the fluorescent dye or to be shorter than 10 picoseconds. When the time interval t2 is set to be equal to or shorter than the relaxation time (for example, T₂ lifetime) between excited triplet states of the fluorescent dye, the next optical pulse PL2 is incident on the object B and absorbed by the fluorescent dye when the molecules of the fluorescent dye are in a higher-order excited triplet state (for example, the excited state T₂). As a result, the molecules of the fluorescent dye transition to an even higher-order excited triplet state (for example, an excited state T₃) (arrow Ac2 in the drawing). Then, the potential energy difference between the excited triplet state and the excited singlet state (for example, the excited state S₁) of the molecules increases, so that the molecules are more likely to transition to the excited singlet state before reacting with oxygen (arrow Ae3 in the drawing). Therefore, destruction of the molecules can be prevented, and as a result, photobleaching can be reduced.

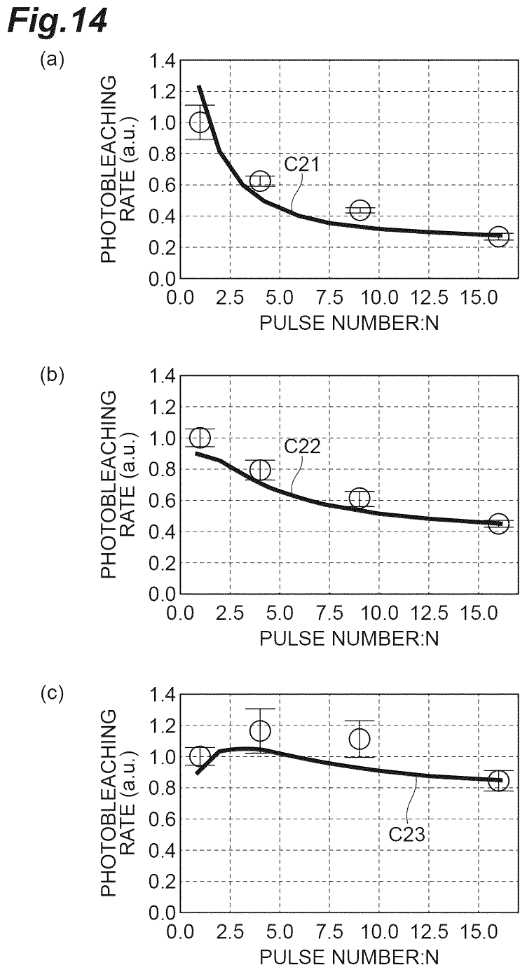

Parts (a) to (c) in FIG. 14 show graphs including the same plots as in the graphs shown in parts (a) to (c) in FIG. 11, respectively. However, curves C21 to C23 show theoretical values calculated based on the above mechanism, unlike the curves C11 to C13 in FIG. 11. Referring to FIG. 14, it can be seen that for all fluorescent dyes, the dependence of the photobleaching rate on the number of pulses (N) is close to the theoretical value. This confirms that the above mechanism is correct.

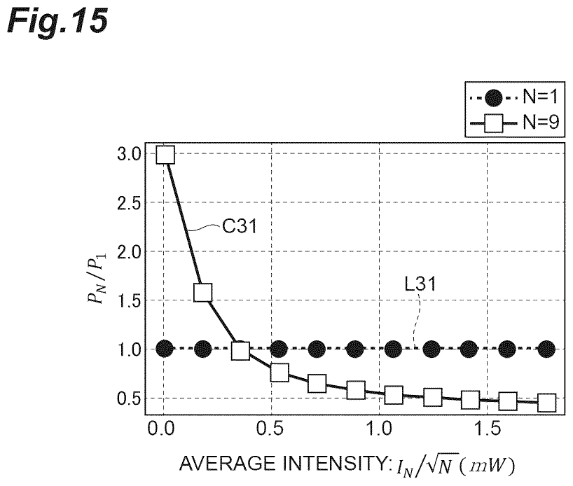

FIG. 15 is a graph showing the theoretical relationship based on the above mechanism between the average intensity (I_{N}/√N) of excitation beam and the value (P_{N}/P₁) obtained by normalizing the photobleaching rate P_{N} with the photobleaching rate P₁ when N=1. In the drawing, a straight line L31 shows a case of N=1, and a curve C31 shows a case of N=9. Comparing FIG. 15 with part (b) in FIG. 12, it can be seen that the experimental values (part (b) in FIG. 12) match well the theoretical values (FIG. 15), at least when the average intensity (I_{N}/√N) of the excitation beam is in the range of 0.4 to 1.6. This also confirms that the above mechanism is correct.

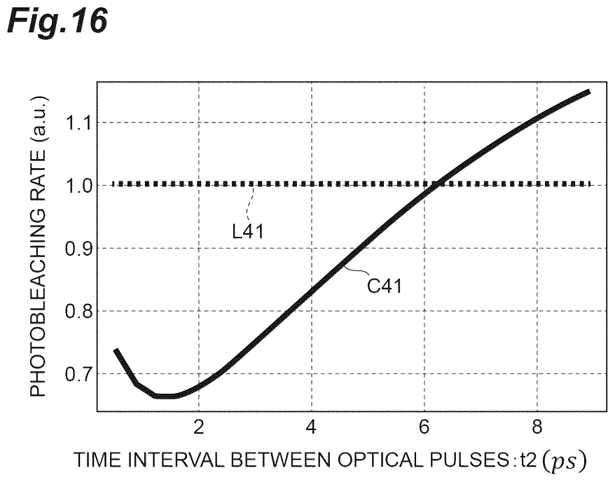

FIG. 16 is a graph showing the results of calculation of the relationship between the time interval t2 between the optical pulses PL2 and the photobleaching rate. In FIG. 16, a straight line L41 shows a case where the excitation beam is a single optical pulse, and a curve C41 shows a case where the excitation beam is an optical pulse group including a plurality of optical pulses. In this calculation, the relaxation time between excited triplet states is set to 5 picoseconds. Referring to this graph, the curve C41 crosses the straight line L41 at the time interval t2 of 6.2 picoseconds, which is slightly longer than the relaxation time (5 picoseconds) between excited triplet states, and when the time interval t2 is shorter than the crossing point, the photobleaching rate shown by the curve C41 is smaller than the photobleaching rate shown by the straight line L41. This shows that if the time interval t2 between the optical pulses PL2 is equal to or shorter than the relaxation time between excited triplet states, the photobleaching rate can be effectively reduced.

There are various fluorescent dyes, some of which have a relaxation time between excited triplet states that is equal to or longer than 10 picoseconds. Among the types of fluorescent dyes described above, anthracene is one such example. By setting the time interval t2 between the optical pulses PL2 to be shorter than 10 picoseconds, it is possible to effectively reduce photobleaching of such a fluorescent dye. By setting the time interval t2 between the optical pulse PL2 to 6 picoseconds or less, it is possible to effectively reduce photobleaching of a fluorescent dye whose relaxation time between excited triplet states is longer than 6 picoseconds. From the calculation results shown in FIG. 16, photobleaching of a fluorescent dye such as Rose Bengal, which has a time interval longer than 5 picoseconds, can also be effectively reduced by setting the time interval t2 between the optical pulses PL2 to 6 picoseconds or less. By setting the time interval t2 between the optical pulse PL2 to be shorter than 2 picoseconds, it is possible to effectively reduce photobleaching of fluorescent dyes whose relaxation time between excited triplet states is equal to or longer than 2 picoseconds (for example, the above-described methanol solution of Rose Bengal, ethanol solution of Rhodamine 6G, Rose Bengal, and anthracene). By setting the time interval t2 between the optical pulses PL2 to be shorter than 1 picosecond, it is possible to effectively reduce photobleaching of fluorescent dyes whose relaxation time between excited triplet states is equal to or longer than 1 picosecond (for example, the above-described methanol solution of Eosin Y, aqueous solution of Eosin Y, methanol solution of Rose Bengal, ethanol solution of Rhodamine 6G, Rose Bengal, and anthracene).

When the time interval t2 between the optical pulses PL2 is set to be equal to or shorter than the relaxation time between excited triplet states, the relaxation time may be the relaxation time from the excited state T₂ to the excited state T₁ (so-called T₂ lifetime). In this case, photobleaching can be effectively reduced in a fluorescent dye having a property of transitioning from the excited state T₁ to the excited state T₂ by the optical pulse PL2.

As in the present embodiment, the image acquisition method may include step S11 of inputting information regarding the type of fluorescent dye before step S12 of generating the optical pulse group PG. Then, in the step S12 of generating the optical pulse group PG, the time interval t2 between the plurality of optical pulses PL2 may be set based on the information so as to be equal to or shorter than the relaxation time between excited triplet states of the fluorescent dye. Similarly, the fluorescence microscope 1 may include the information input section 11 for inputting information regarding the type of fluorescent dye. Based on the information, the pulse group generator 2 may set the time interval t2 between the optical pulses PL2 to be equal to or shorter than the relaxation time between excited triplet states of the fluorescent dye. According to the image acquisition method and the fluorescence microscope 1, the time interval t2 between the optical pulses PL2 can be set according to the relaxation time of the fluorescent dye used. Therefore, photobleaching of the fluorescent dye can be more effectively reduced.

As in the present embodiment, in step S12 of generating the optical pulse group PG, the peak intensities of the plurality of optical pulses PL2 may be made uniform for each optical pulse group PG. Similarly, in the fluorescence microscope 1, the peak intensities of the plurality of optical pulses PL2 may be uniform for each optical pulse group PG. In this case, the peak intensity of the optical pulse PL2 when transitioning to a higher-order excited triplet state (for example, the excited state T₂) becomes approximately equal to the peak intensity of the optical pulse PL2 when transitioning to an even higher-order excited triplet state (for example, the excited state T₃). Therefore, since the transition from a higher-order excited triplet state to an even higher-order excited triplet state is performed efficiently, photobleaching of the fluorescent dye can be more effectively reduced.

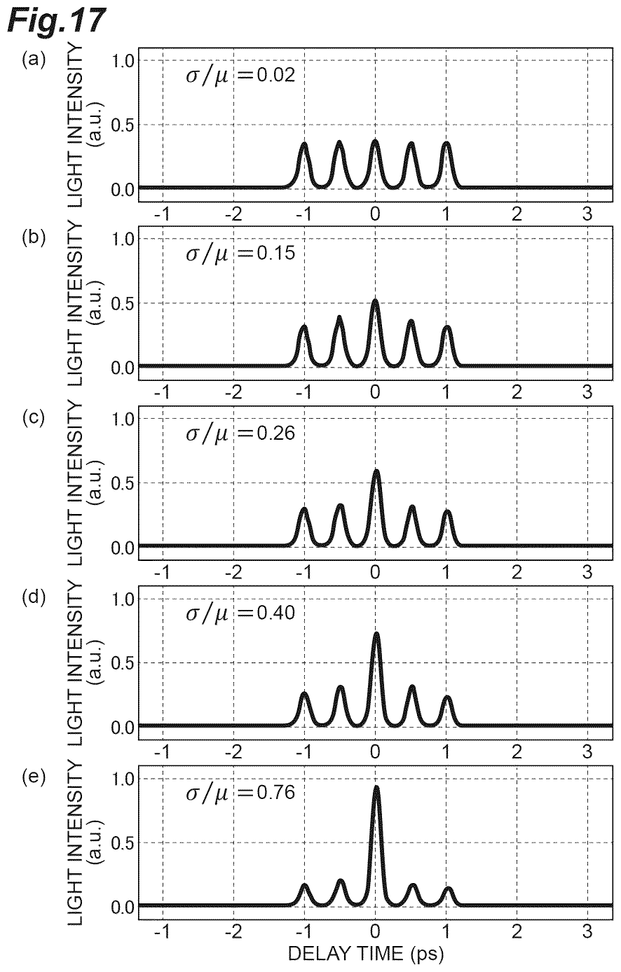

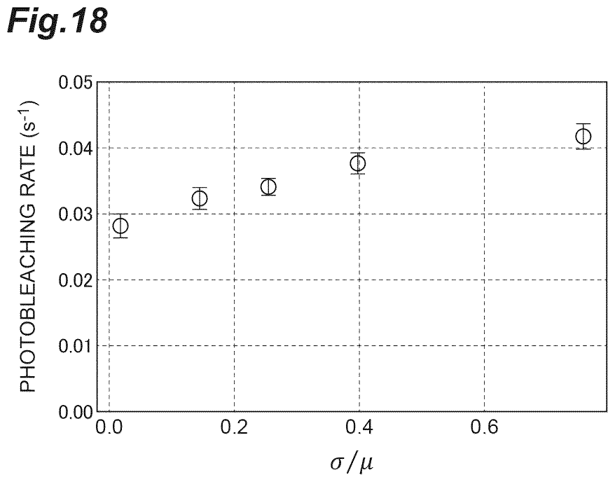

Regarding this matter, the present inventors conducted the following experiments. First, as shown in parts (a) to (e) in FIG. 17, five types of optical pulse groups with different uniformities of peak intensity were generated. Specifically, five types of optical pulse groups were generated with ratios (σ/μ) of the standard deviation σ of the peak intensity of each optical pulse to the average peak intensity μ of each optical pulse being 0.02, 0.15, 0.26, 0.40, and 0.76. Then, the color fading rate when the fluorescent dye was irradiated with these optical pulses was measured. FIG. 18 is a graph showing the results, and shows a relationship between the ratio (σ/μ) and the color fading rate. As is apparent from FIG. 18, the smaller the ratio (σ/μ), that is, the more uniform the peak intensity of the optical pulse, the more the color fading rate is reduced. This result is believed to be due to the fact that as the peak intensity of the optical pulse becomes less uniform, similarity to the case where a single optical pulse is emitted increases. That is, since the peak intensities of the plurality of optical pulses PL2 are uniform for each optical pulse group PG, photobleaching of the fluorescent dye can be reduced more effectively.

As described above, the repetition frequency of the optical pulse group PG may be 1 MHz or more. The relaxation time (for example, T₁ lifetime) of the excited triplet state is several microseconds or less for many fluorescent dyes. Therefore, when the repetition frequency of the optical pulse group PG is 1 MHz or more, in other words, when the repetition period t1 of the optical pulse group PG is 1 microsecond or less, photobleaching due to the mechanism described above is likely to occur, making the image acquisition method and the fluorescence microscope 1 according to the present embodiment useful.

As in the present embodiment, the pulse group generator 2 may include the excitation light source 8 that repeatedly outputs a single optical pulse PL1 and the waveform controller 10 that modulates the single optical pulse PL1 output from the excitation light source 8 to generate a plurality of optical pulses PL2. In this case, the pulse group generator 2 that repeatedly generates the optical pulse group PG including a plurality of optical pulses PL2 can be easily configured.

Here, the configuration and operation of the modulation pattern calculation device 20 will be described in detail. At the same time, a method of calculating a modulation pattern presented to the SLM 14 to generate the optical pulse group PG including a plurality of optical pulses PL2 from the single optical pulse PL1 will be described.

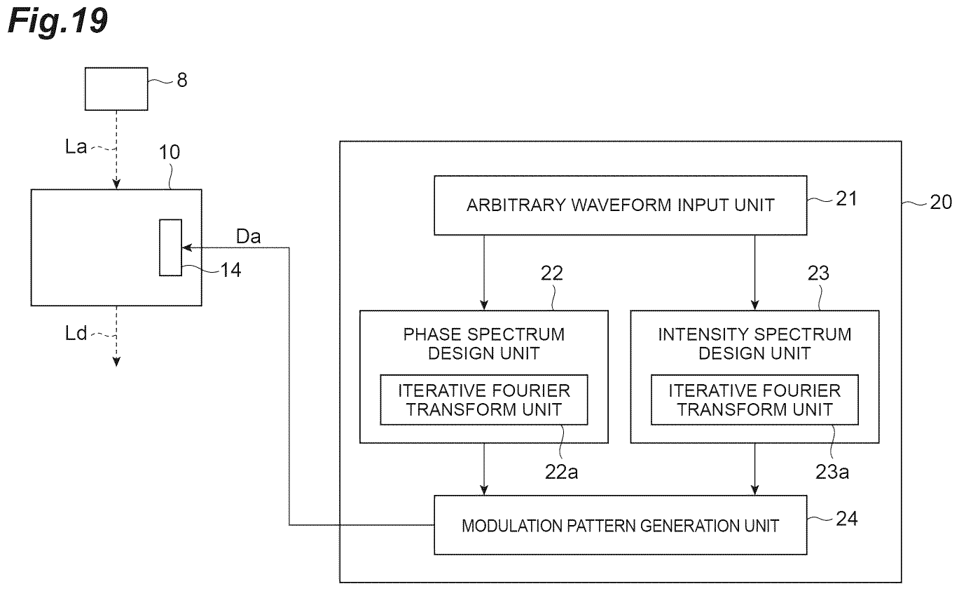

FIG. 19 is a diagram schematically showing the configuration of the modulation pattern calculation device 20. The modulation pattern calculation device 20 is a computer having a processor such as, for example, a personal computer, a smart device such as a smartphone and a tablet terminal, or a cloud server. The modulation pattern calculation device 20 is electrically connected to the SLM 14, calculates a phase modulation pattern for approximating the time intensity waveform of the excitation beam Ld to a waveform including the optical pulse group PG including a plurality of optical pulses PL2, and provides the data Da including the phase modulation pattern to the SLM 14. The modulation pattern calculation device 20 in the present embodiment causes the SLM 14 to present a phase pattern including a phase pattern for phase modulation, which is for applying a phase spectrum to the excitation beam Ld to obtain a waveform including the optical pulse group PG, and a phase pattern for intensity modulation, which is for applying an intensity spectrum to the excitation beam Ld to obtain a waveform including the optical pulse group PG. For this purpose, the modulation pattern calculation device 20 includes an arbitrary waveform input unit 21, a phase spectrum design unit 22, an intensity spectrum design unit 23, and a modulation pattern generation unit 24. That is, a processor of a computer provided in the modulation pattern calculation device 20 realizes the functions of the arbitrary waveform input unit 21, the phase spectrum design unit 22, the intensity spectrum design unit 23, and the modulation pattern generation unit 24. The respective functions may be realized by the same processor or by different processors.

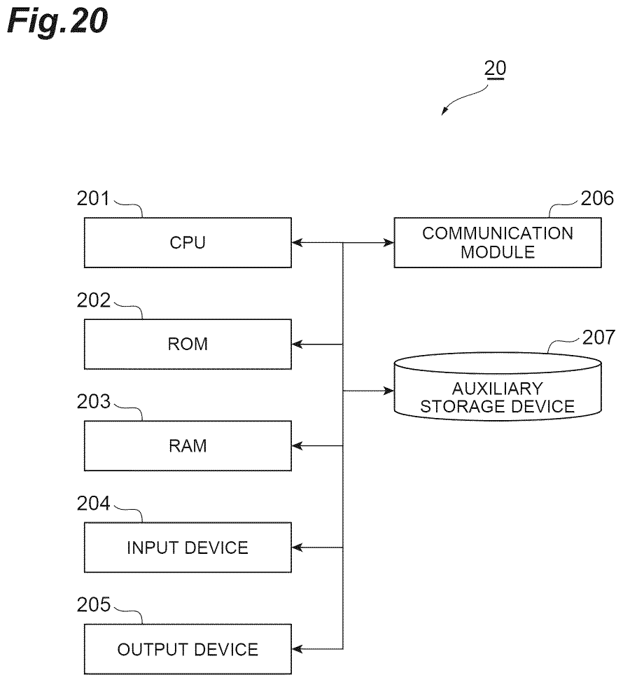

FIG. 20 is a diagram schematically showing an example of the hardware configuration of the modulation pattern calculation device 20. As shown in FIG. 20, the modulation pattern calculation device 20 can be physically configured as a normal computer including: a processor (CPU) 201; a main storage device such as a ROM 202 and a RAM 203; an input device 204 such as a keyboard, a mouse, and a touch screen; an output device 205 such as a display (including a touch screen); a communication module 206 such as a network card for transmitting and receiving data to and from other devices; and an auxiliary storage device 207 such as a hard disk.

The processor 201 of the computer can realize the above-described functions (the arbitrary waveform input unit 21, the phase spectrum design unit 22, the intensity spectrum design unit 23, and the modulation pattern generation unit 24) by using a modulation pattern calculation program. Therefore, the modulation pattern calculation program causes the processor 201 of the computer to operate as the arbitrary waveform input unit 21, the phase spectrum design unit 22, the intensity spectrum design unit 23, and the modulation pattern generation unit 24 in the modulation pattern calculation device 20. The modulation pattern calculation program is stored in a storage device (storage medium) inside or outside the computer, such as the auxiliary storage device 207. The storage device may be a non-transitory recording medium. Examples of recording media include a recording medium such as a flexible disk, a CD, and a DVD, a recording medium such as a ROM, a semiconductor memory, and a cloud server.

The arbitrary waveform input unit 21 receives an input of information regarding the optical pulse group PG from the operator. The operator inputs information regarding the optical pulse group PG (for example, the repetition period t1 of the optical pulse group PG, the pulse width of the optical pulse PL2, the number of pulses in the optical pulse PL2, the time interval t2 between the optical pulses PL2, and the like) to the arbitrary waveform input unit 21. The information regarding the optical pulse group PG is provided to the phase spectrum design unit 22 and the intensity spectrum design unit 23. The phase spectrum design unit 22 calculates the phase spectrum of the excitation beam Ld that is suitable for realizing the waveform of the given optical pulse group PG. The intensity spectrum design unit 23 calculates the intensity spectrum of the excitation beam Ld that is suitable for realizing the waveform of the given optical pulse group PG. The modulation pattern generation unit 24 calculates a phase modulation pattern (for example, a computer-generated hologram) for applying the phase spectrum obtained by the phase spectrum design unit 22 and the intensity spectrum obtained by the intensity spectrum design unit 23 to the excitation beam Ld. Then, the data Da including the calculated phase modulation pattern is provided to the SLM 14, and the SLM 14 is controlled based on the data Da.

Here, a method for calculating the phase spectrum and the intensity spectrum corresponding to the time waveform of the optical pulse group PG will be described in detail. The time waveform of the optical pulse group PG is expressed as a function in the time domain, and the phase spectrum and the intensity spectrum are expressed as functions in the frequency domain. Therefore, the phase spectrum and the intensity spectrum corresponding to the time waveform of the optical pulse group PG are obtained by the iterative Fourier transform based on the time waveform of the optical pulse group PG. In the method described below, the phase spectrum and the intensity spectrum are calculated using an iterative Fourier transform method. For this reason, as shown in FIG. 19, the phase spectrum design unit 22 includes an iterative Fourier transform unit 22a. The intensity spectrum design unit 23 includes an iterative Fourier transform unit 23a.

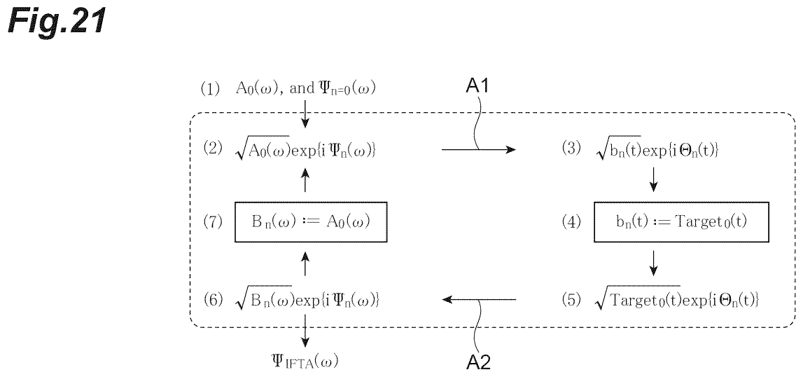

FIG. 21 shows a procedure for calculating the phase spectrum using the iterative Fourier method. First, an initial intensity spectrum function A₀(ω) and a phase spectrum function Ψₙ₌₀(ω), which are functions of a frequency ω, are prepared (process number (1) in the drawing). In one example, the intensity spectrum function A₀(ω) and the phase spectrum function Ψₙ₌₀(ω) represent the intensity spectrum and the phase spectrum of the excitation beam La, respectively. Then, a waveform function (a) in the frequency domain including the intensity spectrum function A₀(ω) and the phase spectrum function Ψₙ(ω) is prepared (process number (2) in the drawing).

$$[ Expression 1 ]$$

$$\sqrt{{A}_{0} ( ω )} exp \{ i {Ψ}_{n} ( ω ) \} \qquad ( a )$$

The subscript n indicates after the n-th Fourier transform process. Before the first Fourier transform process, the above-described initial phase spectrum function Ψₙ₌₀(ω) is used as the phase spectrum function Ψₙ(ω). i is an imaginary unit.

Then, the function (a) is subjected to Fourier transform from the frequency domain to the time domain (arrow A1 in the drawing). As a result, a waveform function (b) in the frequency domain including a time intensity waveform function bₙ(t) is obtained (process number (3) in the drawing).

$$[ Expression 2 ]$$

$$\sqrt{{b}_{n} ( t )} exp \{ i {Θ}_{n} ( t ) \} \qquad ( b )$$

Then, the time intensity waveform function bₙ(t) included in the function (b) is replaced with Target₀(t) based on a desired waveform (process numbers (4) and (5) in the drawing).

$$[ Expression 3 ]$$

$${b}_{n} := {Target}_{0} ( t ) \qquad ( c )$$

$$[ Expression 4 ]$$

$$\sqrt{{Target}_{0} ( t )} exp \{ i {Θ}_{n} ( t ) \} \qquad ( d )$$

Then, the function (d) is subjected to inverse Fourier transform from the time domain to the frequency domain (arrow A2 in the drawing). As a result, a waveform function (e) in the frequency domain including an intensity spectrum function Bₙ(ω) and a phase spectrum function Ψₙ(ω) is obtained (process number (6) in the drawing).

$$[ Expression 5 ]$$

$$\sqrt{{B}_{n} ( ω )} exp \{ i {Ψ}_{n} ( ω ) \} \qquad ( e )$$

Then, in order to constrain the intensity spectrum function Bₙ(ω) included in the function (e), the intensity spectrum function Bₙ(ω) is replaced with the initial intensity spectrum function A₀(ω) (process number (7) in the drawing).

$$[ Expression 6 ]$$

$${B}_{n} ( ω ) := {A}_{0} ( ω ) \qquad ( f )$$

Thereafter, by repeating the above processes (1) to (7) multiple times, the phase spectrum shape represented by the phase spectrum function Ψₙ(ω) in the waveform function can be approximated to the phase spectrum shape corresponding to the time waveform of the desired optical pulse group PG. The finally obtained phase spectrum function Ψ_{IFTA}(ω) is used to calculate a modulation pattern.

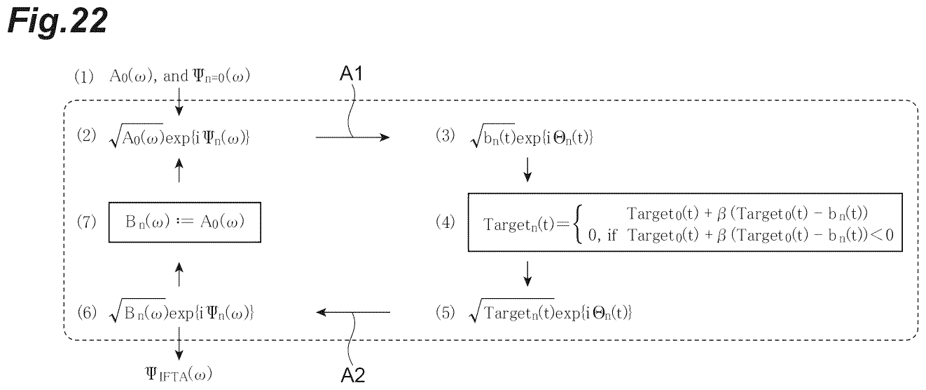

The iterative Fourier method described above may include a process for preventing being led to local solutions. FIG. 22 shows a procedure for calculating the phase spectrum using such an iterative Fourier method (hereinafter, referred to as IFTA-Fienup). In FIG. 22, processes (1) to (3) and (6) to (7) are similar to those in the method described above, and accordingly, explanations thereof will be omitted.

In this IFTA-Fienup, in processes (4) and (5), that is, when performing replacement based on a desired waveform on the time intensity waveform function bₙ(t) included in the function (b) after the Fourier transform, Targetₙ(t) calculated by the following Expression (g) is used instead of Target₀(t) (process numbers (4) and (5) in the drawing).

$$[ Expression 7 ]$$

$${Target}_{n} ( t ) \{ \begin{matrix}{Target}_{0} ( t ) + β ( {Target}_{0} ( t ) - {b}_{n} ( t ) \\ 0 , if {Target}_{0} ( t ) + β ( {Target}_{0} ( t ) - {b}_{n} ( t ) ) < 0\end{matrix} \qquad ( g )$$

$$[ Expression 8 ]$$

$$\sqrt{{Target}_{n} ( t )} exp \{ i {Θ}_{n} ( t ) \} \qquad ( h )$$

In the above Expression (g), Targetₙ(t) is calculated by multiplying a difference (Target₀(t)−bₙ(t)) between the function Target₀(t) representing a desired waveform and the waveform function bₙ(t) after Fourier transform by a predetermined coefficient β and adding this to the desired waveform Target₀(t). When this value is smaller than 0, Targetₙ(t)=0.

However, even this IFTA-Fienup may still lead to a local solution, for example, when the function Target₀(t) representing the desired waveform is significantly different from the waveform function bₙ(t) after Fourier transform.

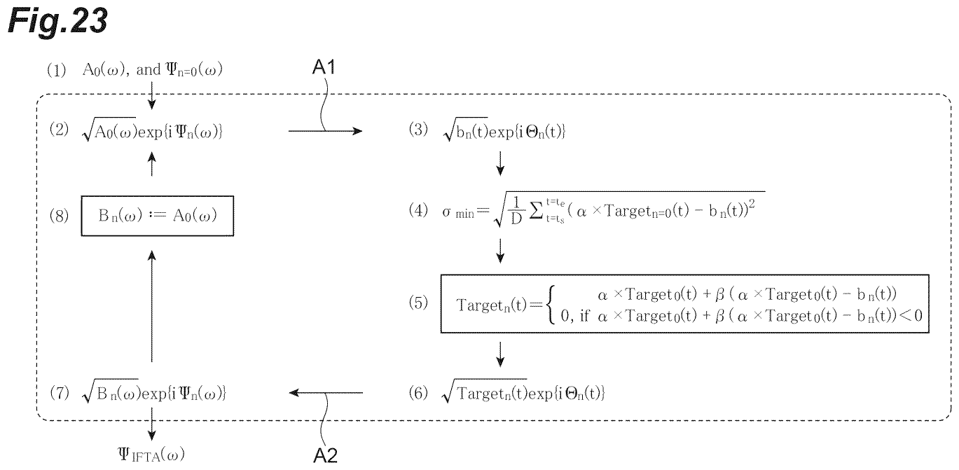

Therefore, the iterative Fourier method may be further improved as described below. FIG. 23 shows a procedure for calculating the phase spectrum. first, an initial intensity spectrum function A₀(ω) and a phase spectrum function Ψₙ₌₀(ω), which are functions of the frequency ω, are prepared (process number (1) in the drawing). In one example, the intensity spectrum function A₀(ω) and the phase spectrum function Ψₙ₌₀(ω) represent the intensity spectrum and the phase spectrum of the input light, respectively.

Then, a waveform function (i) in the frequency domain including the intensity spectrum function A₀(ω) and the phase spectrum function Ψₙ(ω) is prepared (process number (2) in the drawing).

$$[ Expression 9 ]$$

$$\sqrt{{A}_{0} ( ω )} exp \{ i {Ψ}_{n} ( ω ) \} \qquad ( i )$$

The subscript n indicates after the n-th Fourier transform process. Before the first Fourier transform process, the above-described initial phase spectrum function Ψₙ₌₀(ω) is used as the phase spectrum function Ψₙ(ω). i is an imaginary unit.

Then, the function (i) is subjected to Fourier transform from the frequency domain to the time domain. As a result, a waveform function (j) in the frequency domain including a time intensity waveform function bₙ(t) is obtained (process number (3) in the drawing).

$$[ Expression 10 ]$$

$$\sqrt{{b}_{n} ( t )} exp \{ i {Θ}_{n} ( t ) \} \qquad ( j )$$

Then, a coefficient α is found so that the difference between the waveform function bₙ(t) after Fourier transform and (α×Target₀(t)), which is obtained by multiplying the function Target₀(t) by the coefficient α, is smaller than the difference between the waveform function bₙ(t) and the function Target₀(t) (process number (4) in the drawing). In one example, using an evaluation function shown in the following Expression (k), the coefficient α that minimizes (σₘᵢₙ) the standard deviation σ of α×Target₀(t) for the waveform function bₙ(t) after Fourier transform is exploratively derived. In Expression (k), D indicates the number of data points, and tₑ and tₛ indicate the start and end points of the time axis, respectively.

$$[ Expression 11 ]$$

$${σ}_{min} = \frac{]}{D} {\sum }_{t = t}^{t = t} \text{?} {( α \times {Target}_{n = 0} ( t ) - {b}_{n} ( t ) )}^{2} \qquad ( k )$$

$$\text{?} \text{indicates text missing or illegible when filed}$$

Then, replacement based on a desired waveform is performed on the time intensity waveform function bₙ(t) included in the function (j) after the Fourier transform (first replacement). At this time, the replacement is performed using (α×Target₀(t)), which is obtained by multiplying the function Target₀(t) representing a desired waveform by the coefficient α. In one example, the above is replaced with Targetₙ(t) calculated by Expression (m) in which Target₀(t) in Expression (g) in the above IFTA-Fienup is replaced with α×Target₀(t) (process numbers (5) and (6) in the drawing). In the expression, β is an arbitrary coefficient. By appropriately selecting this coefficient β, it is possible to expect the effect of searching for a better solution with a small number of iterations n or the effect of preventing being stuck in local solutions.

$$[ Expression 12 ]$$

$${Target}_{n} ( t ) = \{ \begin{matrix}α \times {Target}_{0} ( t ) + β ( α \times {Target}_{0} ( t ) - {b}_{n} ( t ) ) \\ 0 , if α \times {Target}_{0} ( t ) + β ( α \times {Target}_{0} ( t ) - {b}_{n} ( t ) ) < 0\end{matrix} \qquad ( m )$$

$$[ Expression 13 ]$$

$$\sqrt{{Target}_{n} ( t )} exp \{ i {Θ}_{n} ( t ) \} \qquad ( n )$$

Then, the function (n) is subjected to inverse Fourier transform from the time domain to the frequency domain (arrow A2 in the drawing). As a result, a waveform function (o) in the frequency domain including an intensity spectrum function Bₙ(ω) and a phase spectrum function Ψₙ(ω) is obtained (process number (7) in the drawing).

$$[ Expression 14 ]$$

$$\sqrt{{B}_{n} ( ω )} exp \{ i {Ψ}_{n} ( ω ) \} \qquad ( o )$$

Then, in order to constrain the intensity spectrum function Bₙ(ω) included in the function (o), the above is replaced with the initial intensity spectrum function A₀(ω) (second replacement, process number (8) in the drawing).

$$[ Expression 15 ]$$

$${B}_{n} ( ω ) := {A}_{0} ( ω ) \qquad ( p )$$

Thereafter, by repeating the above processes (1) to (8) multiple times, the phase spectrum shape represented by the phase spectrum function Ψₙ(ω) in the waveform function can be approximated to the phase spectrum shape corresponding to the desired time intensity waveform. The finally obtained phase spectrum function Ψ_{IFTA}(ω) is provided to calculate a modulation pattern.

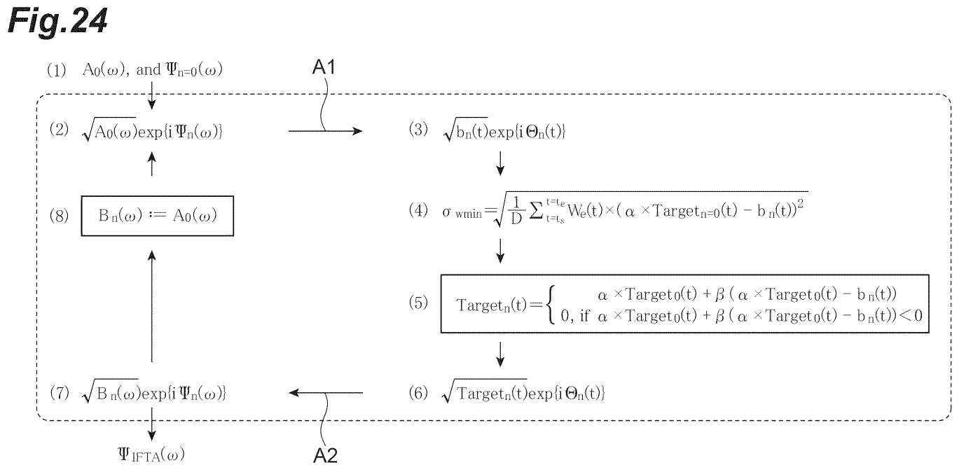

In the iterative Fourier transform unit 22a of the phase spectrum design unit 22, the iterative Fourier method may be further improved as described below. FIG. 24 shows a procedure for calculating the phase spectrum using an improved iterative Fourier method. Since this calculation procedure is similar in many respects to the calculation procedure shown in FIG. 23, explanations thereof will be omitted as appropriate.

First, the iterative Fourier transform unit 22a performs processes indicated by process numbers (1) to (3) that are similar to those in the calculation procedure shown in FIG. 23. Then, the iterative Fourier transform unit 22a finds a coefficient α having the following characteristics (A) and (B) (process number (4) in the drawing).

(A) The difference (α×Target₀(t))−bₙ(t)) between the waveform function bₙ(t) after the Fourier transform and (α×Target₀(t)), which is obtained by multiplying the function Target₀(t) by the coefficient α, is smaller than the difference (Target₀(t)−bₙ(t)) between the waveform function bₙ(t) and the function Target₀(t). Specifically, the time integral value of the difference (α×Target₀(t))−bₙ(t)) is smaller than the time integral value of the difference (Target₀(t)−bₙ(t)).

(B) At each time of the function Target₀(t), the proportion of the above difference (α×Target₀(t))−bₙ(t)), that is, the ratio of the difference (α×Target₀(t))−bₙ(t)) to the intensity value of the function Target₀(t), decreases as the intensity increases.

In one example, using an evaluation function shown in the following Expression (q), the coefficient α that minimizes (σₘᵢₙ) the pseudo standard deviation σ of α×Target₀(t) for the waveform function bₙ(t) after Fourier transform is exploratively derived. In Expression (q), D indicates the number of data points, and tₑ and tₛ indicate the start and end points of the time axis, respectively. We(t) is a first weighting function.

$$[ Expression 16 ]$$

$${σ}_{min} = \sqrt{\frac{1}{D} {\sum }_{t = t}^{t = t} \text{?} We ( t ) \times {( α \times {Target}_{n = 0} ( t ) - {b}_{n} ( t ) )}^{2}} \qquad ( q )$$

$$\text{?} \text{indicates text missing or illegible when filed}$$

As shown in Expression (q), this evaluation function includes a function including the difference (α×Target₀(t)−bₙ(t)) between the waveform function bₙ(t) after Fourier transform and the function α×Target₀(t)) after multiplication, specifically, (α×Target₀(t)−bₙ(t))². In addition, this evaluation function includes a weighting function We(t) multiplied by this function, and includes the time integral of this function multiplied by the weighting function We(t). Then, the coefficient α that minimizes (σₘᵢₙ) this evaluation function, that is, the time integral, is exploratively derived. The weighting function We(t) is a function that has a larger weighting value as the intensity at each time of the function Target₀(t) before multiplication increases. In one example, the weighting function We(t) includes a function obtained by multiplying the function Target₀(t) by another coefficient C₁, and is expressed by, for example, the following Expression (r). In other words, the weighting function We(t) may be determined based on the function Target₀(t).

$$[ Expression 17 ]$$

$$We ( t ) \times {C}_{1} \cdot {Target}_{0} ( t ) \qquad ( r )$$

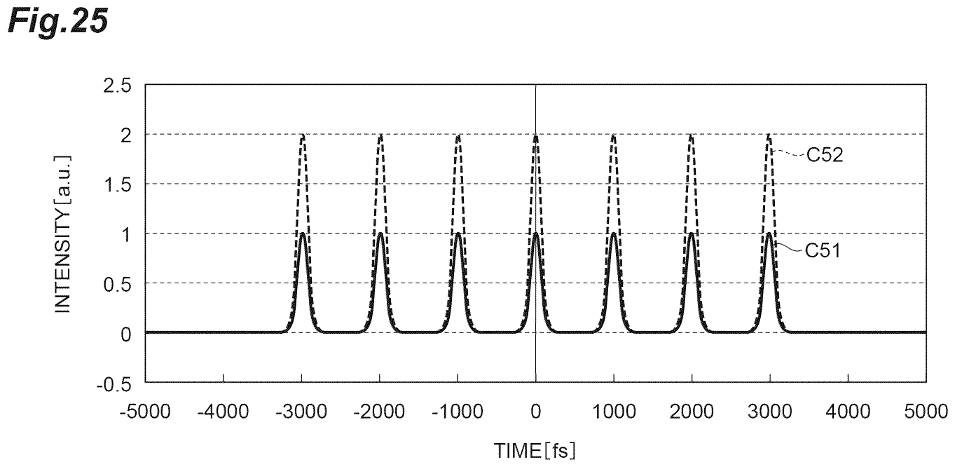

As described above, the evaluation unction shown in Expression (q) includes the weighting function We(t), so that the above-described characteristic (B) can be given to the coefficient α. FIG. 25 shows an example of the weighting function We(t) when Target₀(t) is an optical pulse group including a plurality of optical pulses. A curve C51 in FIG. 25 shows a case where the coefficient C in Expression (r) is 1, and a curve C52 shows a case where the coefficient C Expression (r) is 2.

Thereafter, the iterative Fourier transform unit 22a performs processes indicated by process numbers (5) to (8) that are similar to those in the calculation procedure shown in FIG. 23. Thereafter, by repeating the above processes (1) to (8) multiple times, the phase spectrum shape represented by the phase spectrum function Ψₙ(ω) in the waveform function can be approximated to the phase spectrum shape corresponding to the desired time intensity waveform. The finally obtained phase spectrum function Ψ_{IFTA}(ω) is provided to the modulation pattern generation unit 24.

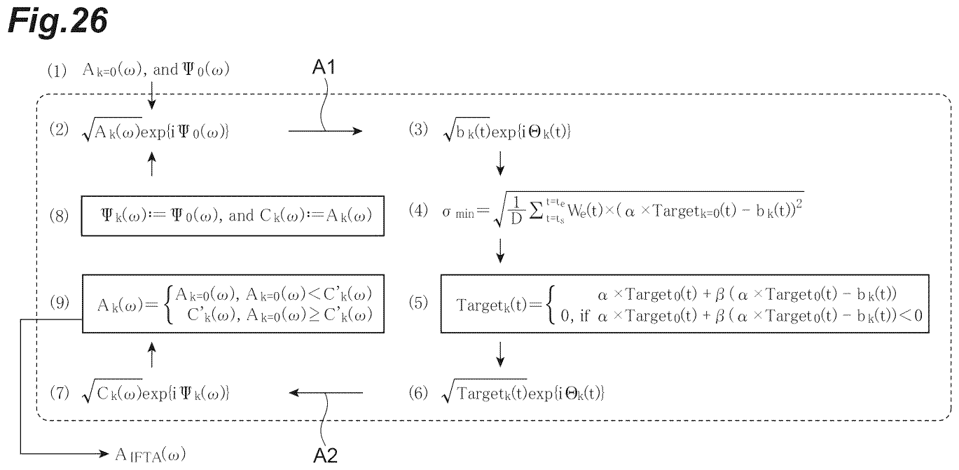

FIG. 26 shows a calculation procedure in the iterative Fourier transform unit 23a of the intensity spectrum design unit 23. The iterative Fourier transform unit 23a calculates an intensity spectrum using a method similar to the calculation method of the iterative Fourier transform unit 22a described above.

First, the iterative Fourier transform unit 23a prepares an initial intensity spectrum function Aₖ₌₀(ω) and a phase spectrum function Ψ₀(ω) in the same manner as when the phase spectrum is calculated (process number (1) in the drawing). Then, the iterative Fourier transform unit 23a prepares a waveform function (s) in the frequency domain including the intensity spectrum function Aₖ(ω) and the phase spectrum function Ψ₀(ω) (process number (2) in the drawing).

$$[ Expression 18 ]$$

$$\sqrt{{A}_{k} ( ω )} exp \{ i {Ψ}_{0} ( ω ) \} \qquad ( s )$$

The subscript k indicates after the k-th Fourier transform process. Before the first Fourier transform process, the above-described initial intensity spectrum function Aₖ₌₀(ω) is used as the intensity spectrum function Aₖ(ω). i is an imaginary unit.

Then, the iterative Fourier transform unit 23a performs a Fourier transform on the function (s) from the frequency domain to the time domain. As a result, a waveform function (t) in the frequency domain including a time intensity waveform function bₖ(t) is obtained (process number (3) in the drawing).

$$[ Expression 19 ]$$

$$\sqrt{{b}_{k} ( t )} exp \{ i {Θ}_{k} ( t ) \} \qquad ( t )$$

Then, the iterative Fourier transform unit 23a finds a coefficient α having the following characteristics (C) and (D) (process number (4) in the drawing).

(C) The difference (α×Target₀(t))−bₖ(t)) between the waveform function bₖ(t) after the Fourier transform and (α×Target₀(t)), which is obtained by multiplying the function Target₀(t) by the coefficient α, is smaller than the difference (Target₀(t)−bₖ(t)) between the waveform function bₖ(t) and the function Target₀(t). Specifically, the time integral value of the difference (α×Target₀(t))−bₖ(t)) is smaller than the time integral value of the difference (Target₀(t)−bₖ(t)).

(D) At each time of the function Target₀(t), the proportion of the above difference (α×Target₀(t))−bₖ(t)), that is, the ratio of the difference (α×Target₀(t))−bₖ(t)) to the intensity value of the function Target₀(t), decreases as the intensity increases.

In one example, using an evaluation function shown in the following Expression (u), the coefficient α that minimizes (σₘᵢₙ) the pseudo standard deviation σ of α×Target₀(t) for the waveform function bₖ(t) after Fourier transform is exploratively derived. In Expression (u), D indicates the number of data points, and tₑ and tₛ indicate the start and end points of the time axis, respectively. We(t) is a first weighting function.

$$\begin{matrix}[ Expression 20 ] & \\ {σ}_{min} = \sqrt{\frac{1}{D} {\sum }_{t = {t}_{s}}^{t = {t}_{e}} We ( t ) \times {( α \times {Target}_{k = 0} ( t ) - {b}_{k} ( t ) )}^{2}} & ( u )\end{matrix}$$

As shown in Expression (u), this evaluation function includes a function including the difference (α×Target₀(t))−bₖ(t)) between the waveform function bₖ(t) after Fourier transform and the function α×Target₀(t)) after multiplication, specifically, (α×Target₀(t))−bₖ(t))². In addition, this evaluation function includes a weighting function We(t) multiplied by this function, and includes the time integral of this function multiplied by the weighting function We(t). Then, the coefficient α that minimizes (σₘᵢₙ) this evaluation function, that is, the time integral, is exploratively derived. The characteristics and specific examples of the weighting function We(t) are similar to those in the case of calculating the phase spectrum function described above (see Expressions (q) and (r)). However, the following Expression (v) is used instead of the above Expression (q).

$$[ Expression 21 ]$$

$${σ}_{min} = \sqrt{\frac{1}{D} {\sum }_{t = t}^{t = t} \text{?} We ( t ) \times {( α \times {Target}_{k = 0} ( t ) - {b}_{k} ( t ) )}^{2}} \qquad ( v )$$

$$\text{?} \text{indicates text missing or illegible when filed}$$

Then, the iterative Fourier transform unit 23a performs replacement based on a desired waveform on the time intensity waveform function bₖ(t) included in the function (v) after the Fourier transform (first replacement). At this time, the iterative Fourier transform unit 23a performs the replacement using (α×Target₀(t)), which is obtained by multiplying the function Target₀(t) representing a desired waveform by the coefficient α. In one example, the above is replaced with Targetₖ(t) calculated by Expression (w) (process numbers (5) and (6) in the drawing).

$$[ Expression 22 ]$$

$${Target}_{k} ( t ) = \{ \begin{matrix}α \times {Target}_{0} ( t ) + β ( α \times {Target}_{0} ( t ) - {b}_{k} ( t ) ) \\ 0 , if α \times {Target}_{0} ( t ) + β ( α \times {Target}_{0} ( t ) - {b}_{k} ( t ) ) < 0\end{matrix} \qquad ( w )$$

$$[ Expression 23 ]$$

$$\sqrt{{Target}_{k} ( t )} exp \{ i {Θ}_{k} ( t ) \} \qquad ( x )$$

Then, the iterative Fourier transform unit 23a performs an inverse Fourier transform on the function (w) from the time domain to the frequency domain. As a result, a waveform function (y) in the frequency domain including an intensity spectrum function Cₖ(ω) and a phase spectrum function Ψₖ(ω) is obtained (process number (7) in the drawing).

$$[ Expression 24 ]$$

$$\sqrt{{C}_{k} ( ω )} exp \{ i {Ψ}_{k} ( ω ) \} \qquad ( y )$$

Then, in order to constrain the phase spectrum function Ψₖ(ω) included in the function (y), the iterative Fourier transform unit 23a replaces the phase spectrum function Ψₖ(ω) with the initial phase spectrum function Ψ₀(ω) (second replacement, process number (8) in the drawing).

$$[ Expression 25 ]$$

$${Ψ}_{k} ( ω ) := {Ψ}_{0} ( ω ) \qquad ( z )$$

The iterative Fourier transform unit 23a performs filtering processing based on the intensity spectrum of the excitation beam La on the intensity spectrum function Cₖ(ω) in the frequency domain after the inverse Fourier transform. Specifically, of the intensity spectrum expressed by the intensity spectrum function Cₖ(ω), a portion exceeding a cutoff intensity for each wavelength determined based on the intensity spectrum of the excitation beam La is cut. In one example, the cutoff frequency for each wavelength is set to match the intensity spectrum of the excitation beam La (in the present embodiment, the initial intensity spectrum function Aₖ₌₀(ω)). In this case, as shown in the following Expression (z1), at frequencies where the intensity spectrum function Cₖ(ω) is larger than the initial intensity spectrum function Aₖ₌₀(ω), the value of the initial intensity spectrum function Aₖ₌₀(ω) is taken as the value of the intensity spectrum function Aₖ(ω). At frequencies where the intensity spectrum function Cₖ(ω) is equal to or less than the initial intensity spectrum function Aₖ₌₀(ω), the value of the intensity spectrum function Cₖ(ω) is taken as the value of the intensity spectrum function Aₖ(ω).

$$[ Expression 26 ]$$

$${A}_{k} ( ω ) = \{ \begin{matrix}{A}_{k = 0} ( ω ) , & {A}_{k = 0} ( ω ) < {C}_{k} ( ω ) \\ {C}_{k} ( ω ) , & {A}_{k = 0} ( ω ) \geq {C}_{k} ( ω )\end{matrix} \qquad ( z 1 )$$

The intensity spectrum function Cₖ(ω) included in the function (y) is replaced with the intensity spectrum function Aₖ(ω) after the filtering processing according to the above Expression (z1). A method may be used in which a function C′ₖ(ω) is defined by multiplying Cₖ(ω) by an arbitrary coefficient and the cutoff intensity is changed relatively (process number (9) in the drawing).

Thereafter, the iterative Fourier transform unit 23a repeats the above processes (1) to (8) (or (1) to (9)) multiple times, so that the intensity spectrum shape represented by the intensity spectrum function Aₖ(ω) in the waveform function can be approximated to the intensity spectrum shape corresponding to the desired time intensity waveform. The finally obtained intensity spectrum function A_{IFTA}(ω) is provided to the modulation pattern generation unit 24.

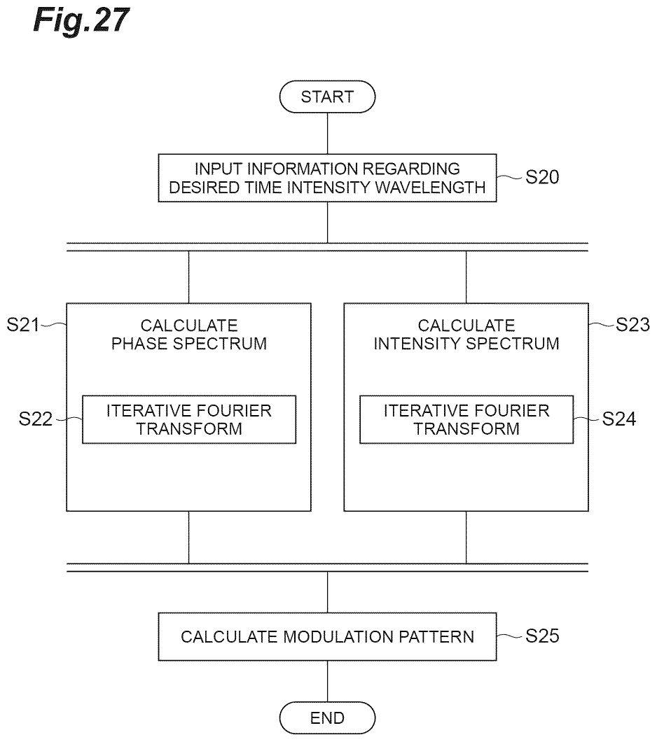

FIG. 27 is a flowchart showing a modulation pattern calculation method realized by the modulation pattern calculation device 20 described above. The modulation pattern calculation program described above causes a processor 201 (see FIG. 20) of a computer to execute each step included in this flowchart. As shown in FIG. 27, first, information regarding the time waveform of a desired optical pulse group PG is input to the arbitrary waveform input unit 21 by an operator (input step S20). Then, the phase spectrum design unit 22 and the intensity spectrum design unit 23 calculate a phase spectrum and an intensity spectrum for approximating the time intensity waveform to a desired waveform, respectively (phase spectrum calculation step S21, intensity spectrum calculation step S23).

The phase spectrum calculation step S21 includes an iterative Fourier transform step S22 by the iterative Fourier transform unit 22a. The details of the iterative Fourier transform step S22 are similar to the operation of the iterative Fourier transform unit 22a described above. The finally obtained phase spectrum function Ψ_{IFTA}(ω) is provided for the subsequent modulation pattern calculation step S25. The intensity spectrum calculation step S23 includes an iterative Fourier transform step S24 by the iterative Fourier transform unit 23a. The details of the iterative Fourier transform step S24 are similar to the operation of the iterative Fourier transform unit 23a described above. The finally obtained intensity spectrum function A_{IFTA}(ω) is provided for the subsequent modulation pattern calculation step S25.

In the modulation pattern calculation step S25, a modulation pattern is calculated based on the phase spectrum function Ψ_{IFTA}(ω) and the intensity spectrum function A_{IFTA}(ω). This modulation pattern is presented to the SLM 14.

In the above description, in order to approximate the time intensity waveform to a desired waveform, both the phase spectrum function Ψ_{IFTA}(ω) and the intensity spectrum function A_{IFTA}(ω) are calculated, and the modulation pattern based on these functions is presented to the SLM 14. Without being limited to such a form, for example, only one of the phase spectrum function Ψ_{IFTA}(ω) and the intensity spectrum function A_{IFTA}(ω) for approximating the time intensity waveform to a desired waveform may be calculated. In this case, a spectrum prepared (or selected) in advance may be used as the other spectrum, or the other spectrum may remain as the excitation beam La without being modulated.

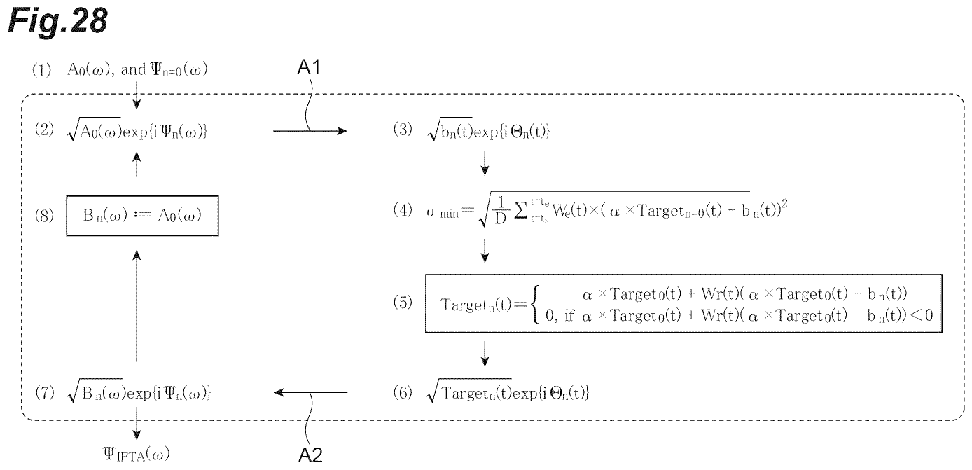

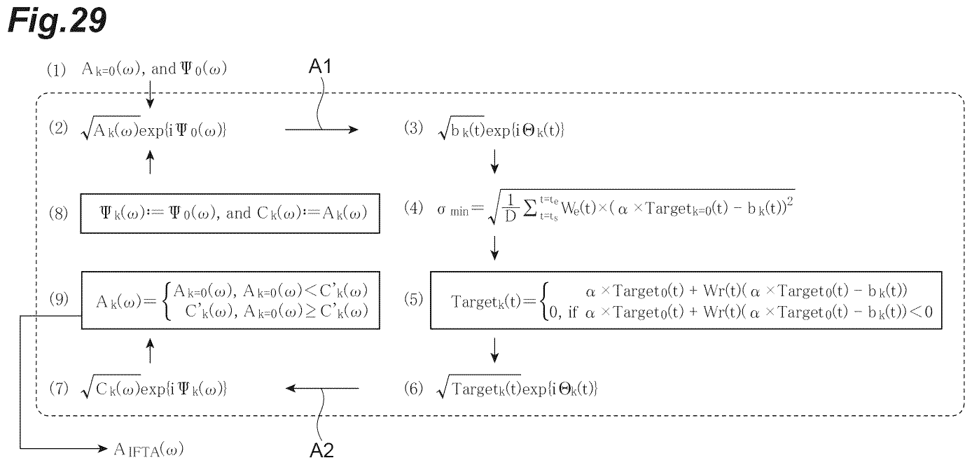

FIGS. 28 and 29 are drawings showing modification examples of the procedure for calculating a phase spectrum by the iterative Fourier method. The difference between this calculation procedure and the above calculation procedure (see FIGS. 24 and 26) is that the coefficient R in process number (5) is replaced with a weighting function Wr(t). In this modification example, the above Expressions (in) and (w) are replaced with the following Expressions (z2) and (z3), respectively.

$$[ Expression 27 ]$$

$${Target}_{n} ( t ) = \{ \begin{matrix}α \times {Target}_{0} ( t ) + Wr ( t ) \cdot ( α \times {Target}_{0} ( t ) - {b}_{n} ( t ) ) \\ 0 , if α \times {Target}_{0} ( t ) + Wr ( t ) \cdot ( α \times {Target}_{0} ( t ) - {b}_{n} ( t ) ) < 0\end{matrix} \qquad ( z 2 )$$

$${Target}_{k} ( t ) = \{ \begin{matrix}α \times {Target}_{0} ( t ) + Wr ( t ) \cdot ( α \times {Target}_{0} ( t ) - {b}_{k} ( t ) ) \\ 0 , if α \times {Target}_{0} ( t ) + Wr ( t ) \cdot ( α \times {Target}_{0} ( t ) - {b}_{k} ( t ) ) < 0\end{matrix} \qquad ( z 3 )$$

That is, in this modification example, the first replacement is performed using the sum of the function {α×Target₀(t)} and a function obtained by multiplying a function, which is obtained by subtracting the time intensity waveform function bₙ(t) (or bₖ(t)) after Fourier transform from the function {α×Target₀(t)}, by the weighting function Wr(t).

The weighting function Wr(t) is a function that has a larger weighting value as the intensity at each time of the function Target₀(t) increases. In one example, the weighting function Wr(t) includes a function obtained by multiplying the function Target₀(t) by another coefficient C₂, and is expressed by, for example, the following Expression. In other words, the weighting function Wr(t) may be determined based on the function Target₀(t).

$$[ Expression 28 ]$$

$$Wr ( t ) = {C}_{2} \cdot {Target}_{0} ( t ) \qquad ( z 4 )$$

By replacing the coefficient β with the weighting function Wr(t), the magnitude of the difference is emphasized in a section of Target₀(t) where the intensity is high, compared to other sections. Therefore, during the iterative Fourier calculation, a result is calculated that particularly reduces the difference in this section. Therefore, the time waveform of the excitation beam Ld in a section where the beam intensity is particularly high can be approximated to the desired waveform with even higher accuracy.

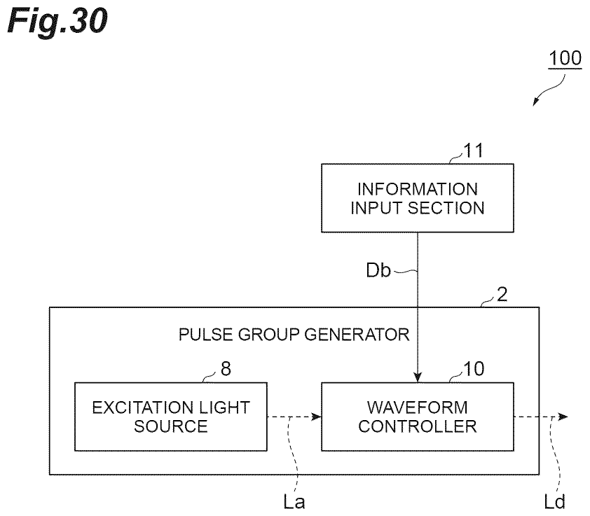

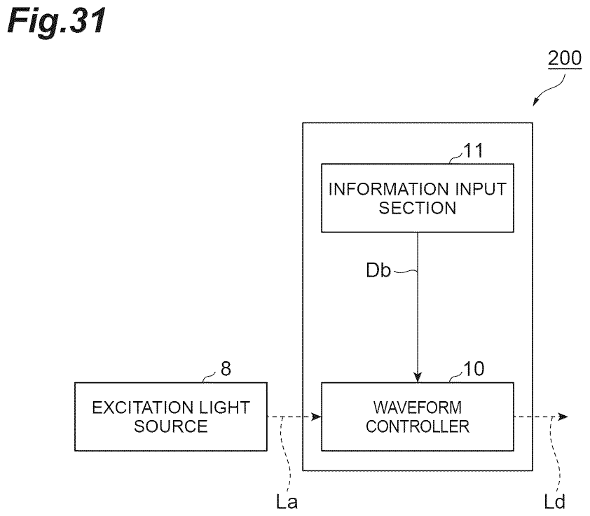

The present invention is not limited to the embodiment described above, and various other modifications can be made. For example, in the above embodiment, the fluorescence microscope 1 including the pulse group generator 2, the optical system 3, the photodetector 4, and the processor 5 has been described. FIG. 30 is a diagram showing an excitation beam irradiation unit 100 used in a fluorescence microscope. The excitation beam irradiation unit 100 includes a pulse group generator 2. The configuration of the pulse group generator 2 is similar to that in the fluorescence microscope 1. The function and effect of the fluorescence microscope 1 according to the embodiment described above are also achieved in the excitation beam irradiation unit 100 in the same manner. The excitation beam irradiation unit 100 may include an information input section 11 in addition to the pulse group generator 2. FIG. 31 is a diagram showing a waveform control unit 200 used in a fluorescence microscope. The waveform control unit 200 repeatedly generates an optical pulse group PG including a plurality of optical pulses PL2 to be emitted to the object B containing a fluorescent dye. For this purpose, the waveform control unit 200 includes a waveform controller 10 optically coupled to an excitation light source 8 provided outside the waveform control unit 200. The waveform controller 10 generates a plurality of optical pulses PL2 by modulating a single optical pulse PL1 output from the excitation light source 8. The function and effect of the fluorescence microscope 1 according to the embodiment described above are also achieved in the waveform control unit 200 in the same manner. The waveform control unit 200 may include an information input section 11 in addition to the waveform controller 10.

### REFERENCE SIGNS LIST

1: fluorescence microscope, 2: pulse group generator, 3: optical system, 4: photodetector, 5: processor, 6: display unit, 7: intensity controller, 8: excitation light source, 9: waveform measuring device, 10: waveform controller, 11: information input section, 12, 16: diffraction grating, 13, 15: lens, 14: spatial light modulator (SLM), 17: modulation surface, 17a: modulation region, 20: modulation pattern calculation device, 21: arbitrary waveform input unit, 22: phase spectrum design unit, 22a: iterative Fourier transform unit, 23: intensity spectrum design unit, 23a: iterative Fourier transform unit, 24: modulation pattern generation unit, 31: beam splitting element, 32, 33: galvanometer mirror, 34, 35: coupling lens, 100: excitation beam irradiation unit, 200: waveform control unit, 201: processor (CPU), 202: ROM, 203: RAM, 204: input device, 205: output device, 206: communication module, 207: auxiliary storage device, B: object, D1, D2: direction, Da: data, Db: information, La: excitation beam, Ld: excitation beam, Le: fluorescence, PG: excitation optical pulse group, PL1: optical pulse, PL2: excitation optical pulse, Sa: electrical signal, Sb: data, t1: repetition period, t2: time interval.

1: An image acquisition method, comprising:
generating an excitation optical pulse group including a plurality of excitation optical pulses repeatedly;
emitting the excitation optical pulse group to an object containing a fluorescent dye;
detecting intensities of fluorescence generated at a plurality of locations of the object due to emission of the excitation optical pulse group; and
generating a fluorescent image based on the intensities of the fluorescence at the plurality of locations of the object,
wherein, in the generating the excitation optical pulse group, a time interval between the plurality of excitation optical pulses is set to be equal to or shorter than a relaxation time between excited triplet states of the fluorescent dye or to be shorter than 10 picoseconds.

2: The image acquisition method according to claim 1,
wherein the relaxation time between excited triplet states of the fluorescent dye is a relaxation time from an excited state T₂ to an excited state T₁.

3: The image acquisition method according to claim 1, further comprising:
inputting information regarding a type of the fluorescent dye before the generating the excitation optical pulse group,
wherein, in the generating the excitation optical pulse group, the time interval between the plurality of excitation optical pulses is set based on the information so as to be equal to or shorter than the relaxation time between excited triplet states of the fluorescent dye.

4: The image acquisition method according to claim 1,
wherein, in the generating the excitation optical pulse group, when setting the time interval between the plurality of excitation optical pulses to be shorter than 10 picoseconds, the time interval between the plurality of excitation optical pulses is set to be shorter than 1 picosecond.

5: The image acquisition method according to claim 1,
wherein, in the generating the excitation optical pulse group, peak intensities of the plurality of excitation optical pulses are made uniform for each excitation optical pulse group.

6: The image acquisition method according to claim 1,
wherein, in the generating the excitation optical pulse group, a repetition frequency for repeatedly generating the excitation optical pulse group is 1 MHz or more.

7: A fluorescence microscope, comprising:
a pulse group generator that repeatedly generates an excitation optical pulse group including a plurality of excitation optical pulses;
an optical system that emits the excitation optical pulse group to an object containing a fluorescent dye;
a photodetector that detects intensities of fluorescence generated at a plurality of locations of the object due to emission of the excitation optical pulse group; and
a processor that generates a fluorescent image based on the intensities of the fluorescence at the plurality of locations of the object,
wherein a time interval between the plurality of excitation optical pulses is set to be equal to or shorter than a relaxation time between excited triplet states of the fluorescent dye or to be shorter than 10 picoseconds.

8: The fluorescence microscope according to claim 7,
wherein the relaxation time between excited triplet states of the fluorescent dye is a relaxation time from an excited state T₂ to an excited state T₁.

9: The fluorescence microscope according to claim 7, further comprising:
an information input section for inputting information regarding a type of the fluorescent dye,
wherein the pulse group generator sets, based on the information, the time interval between the plurality of excitation optical pulses to be equal to or shorter than the relaxation time between excited triplet states of the fluorescent dye.

10: The fluorescence microscope according to claim 7,
wherein, when the time interval between the plurality of excitation optical pulses is shorter than 10 picoseconds, the time interval between the plurality of excitation optical pulses is shorter than 1 picosecond.

11: The fluorescence microscope according to claim 7,
wherein peak intensities of the plurality of excitation optical pulses are uniform for each excitation optical pulse group.

12: The fluorescence microscope according to claim 7,
wherein the pulse group generator includes:
an excitation light source that repeatedly outputs a single optical pulse; and
a waveform controller that is optically coupled to the excitation light source and generates the plurality of excitation optical pulses by modulating the single optical pulse output from the excitation light source.

13: The fluorescence microscope according to claim 7,
wherein a repetition frequency for repeatedly generating the excitation optical pulse group in the pulse group generator is 1 MHz or more.

14: An excitation beam irradiation unit used in a fluorescence microscope, comprising:
a pulse group generator that repeatedly generates an excitation optical pulse group including a plurality of excitation optical pulses to be emitted to an object containing a fluorescent dye,
wherein a time interval between the plurality of excitation optical pulses is equal to or shorter than a relaxation time between excited triplet states of the fluorescent dye or shorter than 10 picoseconds.

15: The excitation beam irradiation unit according to claim 14, further comprising:
an information input section for inputting information regarding a type of the fluorescent dye,
wherein the pulse group generator sets, based on the information, a time interval between the plurality of excitation optical pulses to be equal to or shorter than a relaxation time between excited triplet states of the fluorescent dye.

16: A waveform control unit for a fluorescence microscope that repeatedly generates an excitation optical pulse group including a plurality of excitation optical pulses to be emitted to an object containing a fluorescent dye, the waveform control unit comprising:
a waveform controller that is optically coupled to an excitation light source that repeatedly outputs a single optical pulse and generates the plurality of excitation optical pulses by modulating the single optical pulse output from the excitation light source,
wherein a time interval between the plurality of excitation optical pulses is equal to or shorter than a relaxation time between excited triplet states of the fluorescent dye or shorter than 10 picoseconds.

17: The waveform control unit according to claim 16, further comprising:
an information input section for inputting information regarding a type of the fluorescent dye,
wherein the waveform controller sets, based on the information, the time interval between the plurality of excitation optical pulses to be equal to or shorter than the relaxation time between excited triplet states of the fluorescent dye.
